(19) United States
(12) Patent Application Publication
(10) Pub. No.: US 2026/0292058 A1
(43) Pub. Date: Sep. 24, 2026

(54) SYSTEM

(71) Applicant: SoftBank Group Corp., Tokyo (JP)

(72) Inventor: Yutaka IIDA, Tokyo (JP)

(73) Assignee: SoftBank Group Corp., Tokyo (JP)

(21) Appl. No.: 19/567,324

(22) Filed: Mar. 16, 2026

(30) Foreign Application Priority Data
Mar. 19, 2025 (JP) 2025-045278

(51) Int. Cl. H04M 3/22; G06F 40/205; G06F 40/284; G10L 15/26; G10L 25/63; H04M 3/42

(52) U.S. Cl. CPC H04M 3/2281; G06F 40/284; H04M 3/42059; G06F 40/205; G10L 15/26; G10L 25/63

(57) ABSTRACT

A system includes a processor that is configured to perform initial processing of an incoming call by receiving an incoming call signal and extracting caller information from the incoming call signal, perform initial processing of communication from an unknown caller by comparing the caller information with a database and performing a risk evaluation based on a result of the comparison, analyze caller information by using a generative artificial intelligence model and generate a prompt for determining safety of the caller, interpret a request of a user by using a speech recognition technique and generate a prompt for causing artificial intelligence to originate communication to arrange transportation or make a reservation based on the interpreted request, and recognize an emotion of the user and generate a prompt for providing an appropriate service based on the recognized emotion.

### CROSS-REFERENCE TO RELATED APPLICATION

This application is based on and claims priority under 35 USC 119 from Japanese Patent Application No. 2025-045278 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication management systems for fixed-line and IP-based telephony primarily focus on basic call routing and simple caller identification, and therefore fail to adequately protect users from rapidly evolving risks such as fraud calls, spam calls, and other malicious communications. In particular, existing systems do not sufficiently utilize dynamic risk evaluation based on unknown callers, and often rely only on static blacklists or simple number-based filters, which are easily bypassed and provide limited safety. Furthermore, traditional systems do not effectively integrate generative artificial intelligence models for analyzing caller information and generating decision logic regarding caller safety. As a result, they cannot flexibly adapt to new patterns of fraudulent behavior or provide nuanced judgments that reflect the context and content of communications.

In addition, current solutions for voice-based reservations and ordering services generally require manual operation by the user, such as searching for contact information, dialing numbers, and navigating interactive voice response systems. These operations impose a burden on users, particularly on elderly users or users who are not familiar with complex devices. Existing systems also lack seamless integration between speech recognition, AI-based decision-making, and automatic call origination for transportation arrangements and reservations.

Moreover, conventional systems rarely recognize user emotions during interactions, and therefore cannot adjust the provided services according to the user's emotional state. This limitation results in a poor user experience and may reduce trust in automated systems, especially in stressful or urgent situations.

Additionally, there is a lack of systems that integrate the above advanced functions with existing optical communication units in a way that is easily deployable and that leverages existing communication infrastructure. In particular, there is a need for a system that can control a device extending the functionality of an optical communication unit, convert optical signals into electrical signals, and connect to a communication network while also coordinating high-level AI-based processing.

Accordingly, there is a demand for a system that can: perform robust initial processing of incoming calls including extraction and analysis of caller information; dynamically evaluate risk for unknown callers through database comparison and AI analysis; interpret user requests via speech recognition and automatically originate communications for transportation arrangements, reservations, and orders; recognize user emotions to tailor services; and integrate these functions with optical communication units in a practical and scalable manner.

### SUMMARY

In order to solve the above-described problems, a system according to an embodiment of the present invention comprises a processor configured to execute a plurality of coordinated functions related to communication management, AI-based analysis, voice-based service requests, emotion recognition, and optical communication integration.

The processor is configured to perform initial processing of an incoming call by receiving an incoming call signal and extracting caller information from the incoming call signal. In this manner, the system obtains caller identification data, such as a caller number or other metadata, at an early stage of the call, before the call is directly connected to the user.

The processor is further configured to perform initial processing of communication from an unknown caller by comparing the caller information with a database and performing a risk evaluation based on a result of the comparison. The database may include, for example, records of known fraudulent callers, spam lists, whitelists, historical call logs, and other risk-related information. By referencing this database, the processor can classify the caller as potentially safe, suspicious, or high-risk, and can decide how the system should handle the call, such as blocking, holding, or forwarding to the user.

The processor is also configured to analyze caller information by using a generative artificial intelligence model and generate a prompt for determining safety of the caller. The generative artificial intelligence model may be implemented as a large language model or other generative model capable of processing caller information, contextual data, and historical patterns. The processor supplies the caller information and related context to the generative artificial intelligence model and obtains from the model an inference regarding the safety level of the caller. Based on this inference, the processor generates a prompt or control instruction that guides subsequent system behavior, for example, a prompt instructing the system to treat the call as safe, suspicious, or to request additional verification.

In addition, the processor is configured to interpret a request of a user by using a speech recognition technique and generate a prompt for causing artificial intelligence to originate communication to arrange transportation or make a reservation based on the interpreted request. Specifically, the processor receives audio data representing the user's voice, converts the audio into text by speech recognition, and performs intent analysis and parameter extraction on the recognized text. When the user expresses a desire to call a taxi, arrange other transportation, or make a reservation at a facility or service provider, the processor generates a prompt that instructs an AI-based call origination function to automatically dial an appropriate external destination, negotiate the reservation or arrangement, and confirm details such as time, place, and number of persons.

Furthermore, the processor is configured to recognize an emotion of the user and generate a prompt for providing an appropriate service based on the recognized emotion. The processor may analyze acoustic features of the user's speech, lexical content, and interaction patterns to estimate emotional states such as anxiety, anger, satisfaction, or confusion. Based on the recognized emotion, the processor generates prompts that adjust the system's responses, such as using more polite and reassuring messages, offering additional explanations, or prioritizing urgent service in stressful situations, thereby improving user experience and safety.

According to another aspect, the processor may be configured to interpret various reservations and orders by using speech recognition and generate a prompt for causing artificial intelligence to automatically originate communication and place an order. In this configuration, the processor can handle a broad range of voice-based service requests, including product orders, food delivery, and other reservations, by automatically contacting external parties and completing transactions without requiring the user to manually operate the communication device.

According to a further aspect, the processor may be configured to control a device that expands a function of an optical communication unit and generate a prompt for converting an optical signal into an electrical signal and connecting to a communication network. In this way, the system is able to cooperate with an optical communication unit deployed in a user environment. The processor can control a dedicated extension device that converts optical signals received from the optical communication unit into electrical signals suitable for telephony or data communication, and can manage the connection to a communication network in coordination with the AI-based processing described above.

By combining these functions in a single system, the invention enables integrated protection against fraudulent and spam calls, automated and intelligent handling of user voice requests for transportation, reservations, and orders, adaptive service provision based on user emotions, and seamless integration with existing optical communication infrastructure. As a result, the system effectively solves the aforementioned problems and provides a high level of safety, convenience, and usability for users.

The term “processor” refers to a hardware or software processing unit, such as a CPU, microcontroller, ASIC, FPGA, or a combination of such elements, that executes instructions and performs arithmetic, logical, and control operations to implement the functions of the system.

The term “incoming call signal” refers to a signal received over a communication line or network indicating that an external terminal or caller is attempting to establish a call connection with the system.

The term “caller information” refers to information associated with a calling party, including but not limited to a telephone number, caller ID data, network address, line identifier, or other metadata that identifies or characterizes the caller.

The term “unknown caller” refers to a caller whose caller information is not registered as trusted, whitelisted, or previously known in the system's database, and is not pre-classified as a safe caller.

The term “database” refers to any structured or semi-structured data storage, including relational databases, key-value stores, or in-memory data structures, that stores caller-related information such as spam lists, whitelists, call history, and risk evaluation data.

The term “risk evaluation” refers to a process of assessing the probability or degree of fraud, spam, or other malicious activity associated with a caller or communication, based on database comparison, rules, statistical methods, or AI-based analysis.

The term “generative artificial intelligence model” refers to an artificial intelligence model, such as a large language model or other generative neural network, that is capable of generating text, prompts, or other outputs based on input data and learned patterns.

The term “prompt” refers to data, including text, parameters, or structured instructions, that is supplied to an artificial intelligence model or another processing component in order to cause that component to perform a specific operation or decision, such as determining caller safety or initiating a communication.

The term “safety of the caller” refers to an assessment of whether a caller or communication is likely to be legitimate and non-malicious, as opposed to fraudulent, spam, or otherwise harmful, based on risk evaluation and AI-based analysis.

The term “speech recognition technique” refers to a method or algorithm that processes audio signals representing human speech and converts the audio into text or symbolic data that can be interpreted by the system.

The term “request of a user” refers to a command, query, instruction, or desire expressed by a user, particularly via spoken language, for actions such as arranging transportation, making a reservation, or placing an order.

The term “originate communication” refers to initiating a communication session, such as placing a phone call or starting a voice or data connection, from the system to an external destination.

The term “transportation” refers to a service that moves a person or goods from one location to another, including but not limited to taxis, ride-sharing services, buses, or other transport means that can be arranged by communication.

The term “reservation” refers to an advance booking or appointment made with a service provider, such as a restaurant, hotel, medical facility, transportation provider, or other establishment that accepts scheduled bookings.

The term “emotion of the user” refers to an estimated affective state of the user, such as happiness, sadness, anxiety, anger, or calmness, inferred from speech characteristics, linguistic content, or interaction patterns.

The term “appropriate service” refers to a type, level, or style of service provision that is selected or modified in accordance with system logic, including user context and emotional state, so as to improve safety, comfort, or satisfaction of the user.

The term “various reservations and orders” refers to multiple categories of service requests made by a user, including but not limited to reservations for facilities or events and orders for products, food, or on-demand services.

The term “optical communication unit” refers to a device, such as an optical network unit or optical modem, that transmits and receives communication signals using optical fibers and provides an interface to a communication network.

The term “device that expands a function of an optical communication unit” refers to a device connected to or associated with an optical communication unit that adds, extends, or enhances communication functions, such as telephony control, signal conversion, or AI-based processing.

The term “optical signal” refers to a signal transmitted in the form of light through an optical fiber or similar medium and used for communication in an optical network.

The term “electrical signal” refers to a signal represented by variations in voltage, current, or electromagnetic field in an electrical circuit and suitable for processing by electronic communication equipment.

The term “communication network” refers to any wired or wireless network infrastructure, including telephone networks, IP networks, and broadband networks, that allows transmission and reception of voice, data, or multimedia information between multiple endpoints.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

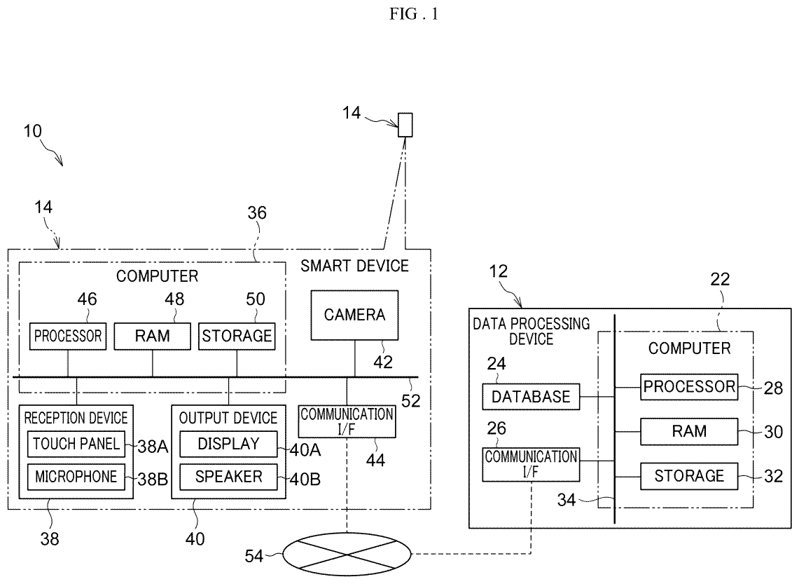

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

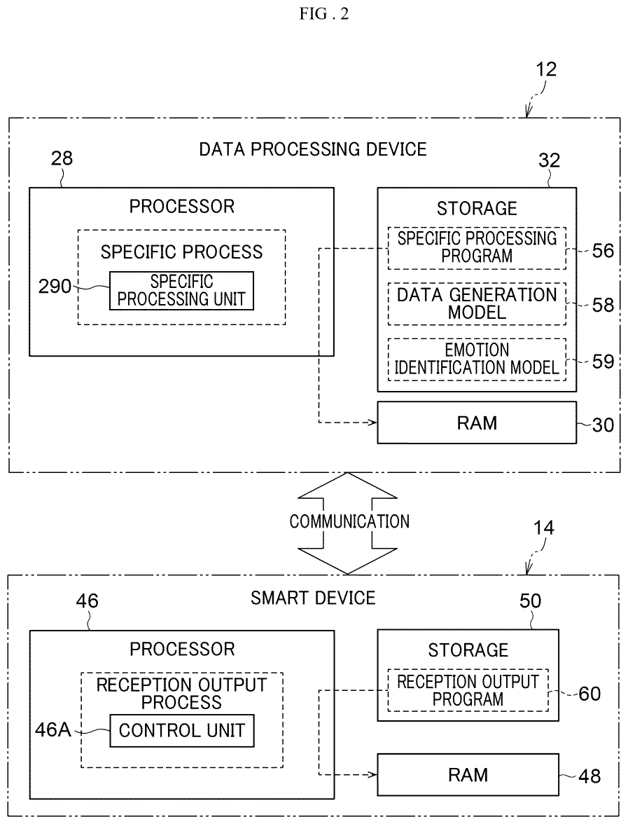

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional telecommunication systems and call-screening mechanisms rely primarily on static rule sets, fixed blacklists, or simple pattern matching against stored caller identifiers. Such systems suffer from several technical limitations. First, because risk evaluation is based on pre-registered entries and manually maintained rules, the systems are unable to adequately respond to dynamically evolving malicious calling patterns, resulting in high false negatives for new or obfuscated spam and fraud calls. Second, when additional AI-based evaluation is employed, the AI component is often loosely coupled, invoked in an ad hoc manner, and not integrated into a closed feedback loop with the call-control logic and user interaction data, which leads to inefficient utilization of computational resources and inconsistent screening accuracy. Third, many existing architectures treat generative AI services merely as passive advisors, without systematic management of prompt sentences, thresholds, and evaluation history, causing redundant network calls, increased latency, and difficulty in adapting the system behavior based on accumulated operation results.

In addition, conventional systems typically do not expose AI-based safety evaluations to end users in a structured and timely fashion via terminal devices, nor do they feed back the user's explicit response operations-such as answering, rejecting, or ignoring screened calls-into the core decision logic. As a result, the computer system cannot refine its decision thresholds or prompt content based on real-world outcomes, and cannot technically improve the quality and efficiency of subsequent call-screening processes. Furthermore, when handling voice-based reservation and ordering operations, traditional systems separate speech recognition, AI reasoning, and network call control into isolated modules, which increases processing overhead, introduces synchronization issues, and degrades end-to-end performance from the perspective of computer resource utilization.

Accordingly, there is a need for a computer-implemented system that integrates: (i) initial call processing and caller identification; (ii) database-based known/unknown classification and risk evaluation; (iii) generation and management of prompt sentences for a generative AI model; (iv) structured ingestion of AI safety evaluation results; and (v) adaptive control of communication connections and user notifications. Such a system should establish a feedback loop in which AI outputs, call outcomes, and user operations are recorded and used to dynamically adjust prompt sentences and decision thresholds. In this way, the underlying computer technology is improved by reducing unnecessary processing, lowering network traffic to AI services, reducing response latency, and increasing the technical accuracy and robustness of automated call screening and AI-assisted communication control.

The specific processing by the specific processing unit 290 of the data processing device 12 in Example 1 is realized by the following means.

The present invention provides a server comprising a processor and a storage device, the processor being configured to perform initial processing of incoming communication signals by extracting identification information, to compare the identification information against information stored in the storage device to determine whether the identification information is known or unknown and to perform risk evaluation on identification information determined to be unknown, to generate a prompt sentence requesting a safety evaluation for the unknown identification information and to transmit the prompt sentence and the identification information to an external generative AI model so as to obtain a safety evaluation result, to analyze the safety evaluation result to generate a determination indicating whether a communication corresponding to the identification information is to be permitted or rejected and to record the determination and the safety evaluation result in the storage device, to generate and transmit a connection control signal to a communication apparatus based on the determination so as to control a connection state of the communication apparatus, to transmit notification information including the identification information, the safety evaluation result, and response options to a terminal device when the determination indicates permission and to control establishment or termination of the communication based on a user response operation received from the terminal device, and to update at least one of content of the prompt sentence and a threshold used in the determination based on the safety evaluation result, the determination, and the user response operation so as to dynamically adjust subsequent safety evaluation processing. This enables a technically improved, closed-loop call-screening and communication-control architecture in which generative AI evaluation, database state, and user behavior are integrated at the processor level to reduce processing overhead, lower latency, adapt decision logic over time, and enhance the accuracy and robustness of automated handling of incoming communications and AI-assisted outgoing reservation or ordering operations.

The term “processor” refers to a hardware computing element, such as a central processing unit or a programmable logic device, that executes instructions to perform arithmetic, logical, control, and input/output operations for implementing the functions of the system.

The term “storage device” refers to a hardware data retention element, such as a memory device or a non-volatile storage medium, that stores programs, configuration data, identification information, evaluation results, and other information used by the processor.

The term “input signal” refers to a communication signal received from a communication apparatus or network interface that contains control information and/or user data relating to an incoming communication.

The term “communication apparatus” refers to a hardware communication unit, such as a fixed communication device, gateway device, or network terminal, that sends and receives communication signals over a communication network.

The term “incoming information” refers to information contained in the input signal, including at least identification information and associated control parameters relating to an incoming communication.

The term “identification information” refers to data that distinguishes a communication source or destination, such as a telephone number, network address, caller identifier, or other identifier associated with a party to a communication.

The term “initial processing” refers to a sequence of operations performed by the processor on a received input signal, including extraction, parsing, normalization, and temporary storage of relevant information, prior to subsequent evaluation and control steps.

The term “information stored in the storage device” refers to any data structure, record, or database entry that is persistently or temporarily maintained in the storage device, including caller profiles, risk scores, evaluation logs, thresholds, and configuration parameters.

The term “known information” refers to identification information for which a corresponding record or profile is stored in the storage device and has been previously classified or trusted according to predefined criteria.

The term “unknown information” refers to identification information for which no corresponding record exists in the storage device or for which no reliable classification has been established.

The term “risk evaluation” refers to processing by which the processor assesses a likelihood that a communication associated with particular identification information is malicious, fraudulent, or otherwise undesirable, based on rules, historical data, or other criteria.

The term “prompt sentence” refers to a text string or structured textual instruction that is generated by the processor and provided as input to a generative AI model in order to request an evaluation, classification, or generation of information.

The term “external generative AI model” refers to a machine-learned model, executed on computing resources that are separate from the server, that generates output data such as natural language text or structured information in response to a prompt sentence, using generative artificial intelligence techniques.

The term “safety evaluation result” refers to output data produced by the generative AI model that indicates an assessment of the safety or risk associated with particular identification information, including labels such as “safe” or “dangerous” and optionally explanatory information.

The term “determination result” refers to a decision generated by the processor, based on the safety evaluation result and optionally other criteria, indicating whether a communication should be permitted, rejected, or otherwise controlled.

The term “connection control signal” refers to a control message or signaling information generated by the processor and transmitted to a communication apparatus in order to establish, maintain, modify, or terminate a communication connection.

The term “connection state” refers to a status of a communication path in the communication apparatus, including states such as idle, ringing, connected, on hold, or terminated.

The term “terminal device” refers to a user-operable device, such as a mobile device, portable terminal, or user interface device, that can receive notification information from the server and transmit user response operations back to the server.

The term “notification information” refers to data transmitted from the processor to the terminal device that includes at least identification information, a safety evaluation result, and available response options relating to a communication.

The term “user response operation” refers to an action performed by a user on the terminal device in response to notification information, such as selecting to answer, reject, or ignore a communication.

The term “establishment of the communication” refers to processing by which a communication channel is set up, through signaling and resource allocation, so that data exchange between communication endpoints can occur.

The term “termination of the communication” refers to processing by which an existing or pending communication channel is ended through signaling and release of associated resources.

The term “threshold” refers to a parameter value or set of parameter values used by the processor to classify or decide a result, such as a boundary between safe and dangerous conditions or a confidence level required for a particular decision.

The term “subsequent safety evaluation processing” refers to safety-related evaluation operations performed after a previous communication has been processed, including later evaluations that are influenced by updated prompt sentences, thresholds, or accumulated operation history.

The term “user voice input” refers to an audio signal representing speech uttered by a user and captured by a microphone or similar audio input device connected to the terminal device.

The term “voice recognition processing” refers to computational operations that convert user voice input into machine-readable text or commands by applying speech recognition algorithms or models.

The term “reservation request” refers to a request by a user to book a resource or service, such as transportation, accommodation, or appointment, expressed in natural language or structured form.

The term “order request” refers to a request by a user to purchase or obtain goods or services, expressed in natural language or structured form.

The term “outgoing process” refers to a sequence of operations that initiates a communication from the server or communication apparatus toward an external destination for purposes such as reservation or ordering.

The term “response result” refers to information obtained from the generative AI model in reply to a prompt sentence, including generated text, recommended actions, or structured data used by the processor to perform further processing.

The term “optical communication element” refers to a hardware component or module that transmits or receives optical signals over an optical medium and may perform conversion between optical signals and electrical signals.

The term “optical signal” refers to a communication signal represented as modulated light transmitted through an optical medium such as an optical fiber.

The term “electrical signal” refers to a communication signal represented as a variation of electrical quantities such as voltage or current, suitable for processing by electronic circuitry.

The term “communication network” refers to an interconnected system of communication lines and nodes, such as a public network, private network, or packet-switched network, that carries communication signals between endpoints.

The term “connection control information” refers to data that specifies how to configure, establish, or manage a connection between the optical communication element, the communication apparatus, and the communication network, including parameters for conversion and routing.

In one embodiment, a server is implemented as a computer system including at least one processor, a main memory, a nonvolatile storage device, a network interface, and an interface to a communication apparatus. The server is connected to a fixed communication apparatus via an optical communication element, and is further connected to a communication network such as a packet-switched network. The server is also communicatively coupled to at least one terminal operated by a user, such as a smartphone, tablet, or other user device, via a wireless or wired network.

The server stores, in the nonvolatile storage device, a plurality of software modules including an operating system such as a general-purpose server operating system, a database management system such as a relational database engine, a communication control module, a call-screening module, a prompt-management module, an AI-integration module, a user-notification module, and a logging and feedback module. The server loads and executes these modules in the main memory under control of the processor. The server further stores configuration data, caller profile records, call-session records, AI evaluation logs, threshold parameters, and prompt templates in the database managed by the database management system.

The server controls the communication apparatus by using a signaling protocol such as a session control protocol, and the server exchanges signaling messages with the communication apparatus through the optical communication element and the network interface. The optical communication element converts incoming optical signals into electrical signals, and the network interface converts these electrical signals into packet data that the server can process in software. Conversely, the server outputs electrical signals via the network interface, which are converted into optical signals by the optical communication element and then transmitted to the communication apparatus.

The server maintains a caller profile table in the database, where each record includes at least a caller identifier (for example, a telephone number or network identifier), a classification flag indicating whether the caller is known or unknown, a safety label such as “safe” or “dangerous”, a risk score, one or more timestamps, and references to stored AI evaluation results. The server also maintains a call-session table in the database or in memory, where each record stores a call identifier, associated identification information, timestamps, current call state, associated AI evaluation identifiers, and user response results.

The server executes the call-screening module when an incoming communication occurs. The call-screening module extracts identification information such as a phone number from signaling data received from the communication apparatus. The server uses the database management system, via an application-level data access layer, to perform a lookup of the identification information in the caller profile table. The server writes the classification result, and, if necessary, an indication of an unknown caller, into the call-session table.

The server, when the identification information is unknown or associated with insufficiently reliable prior information, invokes the prompt-management module to generate a prompt sentence for a generative AI model. The server stores multiple prompt templates as text patterns in the database or configuration files. Each prompt template may include placeholders for insertion of the identification information and additional context. For example, one prompt template stored by the server is:

“Is this phone number safe? Phone number: [NUMBER]. Classify it as ‘safe’ or ‘dangerous’ and briefly explain why.”

Another prompt template stored by the server is:

“Evaluate the safety of the following caller: [NUMBER]. Consider typical patterns of spam and fraud calls and any known public information. Answer with ‘safe’ or ‘dangerous’ and provide a short reason.”

The server replaces the placeholder “[NUMBER]” with the actual identification information for the current call and generates a concrete prompt sentence. The server records the generated prompt sentence in the call-session record or in a separate prompt-log table. The server integrates with an external generative AI model by using the AI-integration module. The generative AI model is implemented, in one embodiment, as a neural network of the transformer type, comprising an embedding layer, a plurality of multi-head self-attention layers, feed-forward layers, and an output projection layer. The generative AI model is trained on large-scale text corpora using supervised and unsupervised learning, with an objective function such as cross-entropy loss over sequences of tokens. During training, the generative AI model adjusts its weight parameters by gradient descent methods such as stochastic gradient descent or adaptive gradient algorithms, and updates its parameters based on backpropagation of the loss gradient. The generative AI model thus learns statistical relationships between patterns in telephone number formats, associated textual descriptions of spam or fraud, and contextual indicators of risk.

The server does not train the generative AI model in this embodiment but invokes a pre-trained model provided as a network service. The server transmits the generated prompt sentence and the identification information to the generative AI model over a secure network connection such as an HTTPS connection using the network interface. The server sends request data including the prompt sentence, a model identifier, and control parameters such as maximum output length and sampling temperature. The server receives, in response, a text output from the generative AI model via the AI-integration module.

The generative AI model, based on its internal transformer architecture, converts the prompt sentence into token embeddings, applies multiple layers of self-attention with learned attention weights over the token sequence, combines contextual information about the identification information with past learned patterns of spam and safe callers, and produces probability distributions over output tokens at each step. The model then selects tokens with high probability according to the control parameters and outputs a natural language evaluation describing whether the number appears safe or dangerous and why. Due to this architecture, the generative AI model can exploit high-dimensional patterns across many features, such as number prefixes, language regions, typical fraud phrases, and semantic context in the prompt sentence, which cannot be easily captured by simple rule-based filters. The server receives the output text and records the raw AI response in an evaluation-log table together with the correlated call identifier and identification information. The server uses the call-screening module to analyze the AI response. The server, in one embodiment, employs a lightweight natural language parser that identifies keywords such as “safe” or “dangerous” using pattern matching and simple tokenization. The server may also restrict the prompt format to instruct the generative AI model to answer with a specific pattern, such that parsing is deterministic and computationally simple, which reduces processing time and parsing errors. For example, the server may use the prompt sentence:

“Is this phone number safe? Phone number: [NUMBER]. Please answer exactly with one of the following words: ‘safe’ or ‘dangerous’, and then provide a brief explanation.”

The server extracts the label “safe” or “dangerous” and the associated explanation from the AI response and converts these into structured data fields stored in the caller profile table and the call-session table.

The server applies a threshold-based decision algorithm to the AI evaluation result. The server assigns numerical risk scores to labels, for example assigning a lower risk score to “safe” and a higher risk score to “dangerous”. The server may also consider additional features such as the length of the explanation, the presence of specific warning words, or the frequency with which the same identification information has previously been labeled as high risk. The server compares the computed risk score against stored threshold values in the storage device. The threshold values can differ depending on user preferences or service levels. If the risk score exceeds a rejection threshold, the server designates the communication as to be rejected. If the risk score is below an acceptance threshold, the server designates the communication as to be permitted. If the risk score falls between thresholds, the server can mark the call as needing additional user confirmation or may request a second AI evaluation using a different prompt template.

The server generates connection control signals according to the decision. When the communication is to be permitted, the server prepares a control message for the communication apparatus that maintains or transitions the call to a ringing or connectable state. When the communication is to be rejected, the server prepares a termination or refusal message that causes the communication apparatus to drop the call without connecting it to any user device. The server transmits these control messages through the network interface and optical communication element, and the communication apparatus changes its connection state accordingly. This direct control over the hardware communication path ensures that the AI-based evaluation influences real-world signal routing, not merely a software flag. The server, when permitting the communication, uses the user-notification module to construct notification information that includes the identification information, the AI safety label, and the AI explanation. The server transmits this notification to the terminal using a communication method such as a push-notification protocol or a persistent communication channel. The server includes information about available user response options, such as “answer” or “reject”.

The terminal includes at least one processor, an operating system such as a mobile operating system, a graphical user interface framework, a communication module, and an input module including a touchscreen and optional buttons. The terminal executes an application that communicates with the server. The terminal receives the notification information and stores it in local memory. The terminal displays, on its display device, the identification information of the caller, such as a phone number, accompanied by textual indicators like “Screened: safe” or “Screened: dangerous” depending on the AI evaluation, and a brief explanation such as “Known business line, no spam history found” or “Frequently reported as spam and phishing.”

The user views the information displayed by the terminal and performs a response operation such as touching an “Answer” or “Reject” control on the terminal's touchscreen. The terminal detects the user input through the input module and passes the response operation to the application. The terminal then sends a message to the server via the communication module, indicating the call identifier and the user's response. The server receives this response operation and updates the call-session record. When the user chooses to answer, the server sends a connect signal to the communication apparatus, establishing the communication path. When the user chooses to reject, the server sends a termination signal, thereby ending the call.

The server records the fact that a user answered or rejected a call labeled “safe” or “dangerous”. The server retains this information in the database as historical data. In another embodiment, the server periodically analyzes this historical data with an offline or background analysis module. The server computes statistics such as the rate at which users accept calls labeled “safe”, the rate at which users override an “unsafe” label by answering anyway, and the frequency of repeated calls from numbers classified as “dangerous”. Based on these statistics, the server adjusts its threshold parameters and may modify its prompt templates. For instance, when the server detects that many calls labeled “safe” are nevertheless rejected by users, the server may tighten its acceptance threshold or change the prompt sentence to encourage more conservative AI evaluations, such as:

“Evaluate the safety of this phone number: [NUMBER]. If there is any indication of spam, fraud, or suspicious activity, classify it as ‘dangerous’. Answer with ‘safe’ or ‘dangerous’ and give a short reason.”

By updating prompt sentences and thresholds in response to concrete operational outcomes, the server forms a closed feedback loop that improves decision accuracy and reduces misclassifications over time. This dynamic adjustment is not a mere automation of human judgment; instead, it exploits machine-readable statistics and AI behavior to recalibrate the entire call-screening pipeline, yielding technical benefits such as reduced false positives and false negatives, lower repeated AI calls, and improved computational efficiency.

In another embodiment, the server is configured to handle user voice input for reservation or ordering operations. The terminal captures user voice input via a microphone and transfers the captured audio stream to the server. The server applies a speech recognition engine, such as an automatic speech recognition model, to convert the audio signal into text. The server then parses the recognized text to identify entities such as dates, times, destinations, and service types. The server generates a prompt sentence for the generative AI model that includes the extracted entities and a description of the desired task. For example, the server may use a prompt sentence such as:

“The user wants to book transportation. Request: ‘Book a taxi to the airport tomorrow at 10 am.’ Please confirm the intent and provide structured instructions on how to place a call to complete the booking.”

The generative AI model returns a structured natural language description of the steps to complete the reservation, or a more concise command-like text. The server parses this AI response and translates it into a sequence of control actions, such as selecting an appropriate service provider number from a database, initiating an outgoing call via the communication apparatus, and providing prefilled information to an automated reservation system. In this embodiment, the server combines speech recognition, AI reasoning, and network call control into a tightly coordinated processing chain rather than separate siloed functions. This reduces latency, minimizes redundant parsing steps, and improves the accuracy of converting ambiguous human speech into deterministic control actions.

From a technical perspective, the server improves computer technology by employing specific data structures and algorithms to manage AI evaluations efficiently. The server stores prompt templates in normalized tables and maintains indexed records of AI results and user responses. The server issues AI evaluations only for callers classified as unknown or uncertain, thereby reducing the number of AI calls and conserving network bandwidth. The server also normalizes AI outputs into fixed fields, such as discrete labels and compact explanations, which can be indexed and quickly retrieved, thus improving query performance during subsequent screenings. These structures and algorithms optimize data flow between the server, the generative AI model, the communication apparatus, and the terminal, reducing end-to-end processing time and improving throughput under high call volumes.

The server further uses nonconventional processing rules by not simply replacing human decisions, but by incorporating AI-derived safety labels as machine-processable signals that directly influence hardware-level call control. For example, the server may implement a rule that blocks all calls with a cumulative risk score above a specified value, regardless of user input, when certain thresholds are met, such as repeated “dangerous” evaluations and repeated user rejections. This type of rule, based on aggregated AI outputs and user behavior, reduces unnecessary ringing at the communication apparatus and decreases the load on downstream voice channels. This results in lower resource usage on the communication apparatus and the network infrastructure.

In another variation, the server can integrate multiple generative AI models, or a generative model with a smaller discriminative classifier, to cross-check safety evaluations when the identification information exhibits ambiguous patterns. The server maintains separate fields for each model's evaluation and applies a combination algorithm, such as majority voting or weighted averaging of risk scores, to reach a final decision. The server can configure one model to be highly conservative and another to be more permissive; the server then selects which model to consult based on factors like time of day, call density, or user preference, thereby further optimizing computational resources.

In still another embodiment, the server stores historical AI outputs and uses them to train or update a local lightweight classifier that approximates the behavior of the generative AI model for frequently occurring identification information patterns. By offloading part of the decision-making to this local classifier for common cases, the server reduces the number of remote calls to the external generative AI model. This reduces communication latency, network traffic, and cost, while still preserving high accuracy by periodically synchronizing or recalibrating the local classifier using fresh AI outputs.

By the above configurations, the server, in cooperation with the terminal and the communication apparatus, achieves technical effects beyond mere automation of human decision-making. The server dynamically controls optical and electrical signal paths, reduces computational load by selective use of the generative AI model, improves storage efficiency by structuring AI results, and adapts decision logic through a feedback loop based on actual user behavior and call outcomes. These features collectively provide improved processing speed, higher safety classification accuracy, reduced network load, and enhanced robustness against evolving malicious communication patterns.

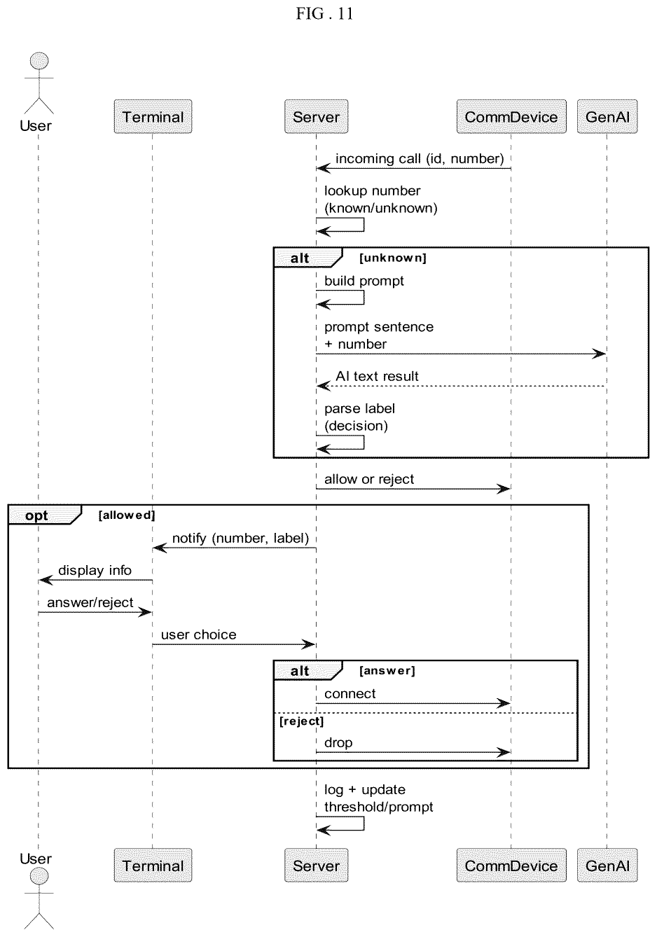

The following describes the processing flow using FIG. 11.

### Step 1:

Server receives signaling data from the communication apparatus through the optical communication element.

Server takes, as input, an electrical signal converted from an optical signal carrying an incoming call request, including a signaling message. Server decodes the signaling protocol, parses header fields, and extracts identification information such as a caller number and a call identifier. Server stores these values in a call-session record in memory or in a database, and outputs a structured call-session object containing at least the call identifier and the identification information.

### Step 2:

Server determines whether the identification information is known or unknown by accessing the storage device.

Server takes, as input, the identification information from the call-session object. Server executes a database query against a caller profile table, using the identification information as a key. Server compares the query result to predefined conditions: when a matching record with a known or trusted flag is found, Server classifies the caller as known; otherwise, Server classifies the caller as unknown. Server writes the classification result into the call-session record and outputs an updated call-session object with a status field set to “known” or “unknown”.

### Step 3:

Server performs preliminary risk evaluation for unknown identification information using stored rules and statistics.

Server takes, as input, the call-session object with status “unknown” and any historical records related to the same identification pattern (for example, prefix or partial match). Server applies rule-based logic, such as checking whether the number has been blocked in the past or whether it matches high-risk patterns (e.g., unusual country codes). Server computes an initial risk score using arithmetic operations over counters and flags stored in the database. Server stores this initial risk score in the call-session record and outputs a call-session object that includes the preliminary risk evaluation.

### Step 4:

Server generates a prompt sentence for the generative AI model based on the unknown identification information and the preliminary risk evaluation.

Server takes, as input, the call-session object containing the identification information and the preliminary risk score. Server selects a prompt template from a prompt-template set stored in the storage device, using the preliminary risk score or system configuration to choose a more conservative or standard template. Server replaces placeholders in the selected template with the actual identification information. For example, Server may generate:

“Is this phone number safe? Phone number: +81-3-1234-5678. Please answer exactly with ‘safe’ or ‘dangerous’ and then provide a brief explanation.”

Server records the generated prompt sentence in a prompt-log table linked to the call identifier and outputs a prompt object containing the concrete prompt sentence and the identification information.

### Step 5:

Server sends the prompt sentence and associated parameters to the external generative AI model and waits for a response.

Server takes, as input, the prompt object, model configuration settings (such as model name and maximum output length), and authentication credentials for the AI service. Server constructs a request payload including the prompt sentence, the identification information, and control parameters. Server opens a secure network connection using the network interface and transmits the request to the generative AI model endpoint. Server then enters a waiting state, monitoring the connection until a response is received. Server outputs a raw AI response once the generative AI model returns generated text.

### Step 6:

Server interprets the AI response and converts it into a structured safety evaluation result. Server takes, as input, the raw AI response text and the associated call identifier. Server applies a parsing routine that separates the label (“safe” or “dangerous”) from the explanation text, using pattern matching and tokenization, based on the known format requested in the prompt sentence. Server maps the textual label to an internal code, such as 0 for safe and 1 for dangerous, and may compute a confidence value based on the presence of certain keywords in the explanation. Server stores the label, code, and explanation in an AI-evaluation table associated with the identification information and the call identifier. Server outputs a safety evaluation object containing the label, explanation, and any computed scores.

### Step 7:

Server computes a final decision to permit or reject the communication based on the safety evaluation result and stored thresholds.

Server takes, as input, the safety evaluation object, threshold parameters stored in the storage device, and any historical AI results for the same identification information. Server performs arithmetic operations to calculate an aggregated risk score, for example by combining the AI-derived risk code with historical counts of dangerous evaluations and past user rejections. Server compares the aggregated risk score against the stored thresholds. When the score is below an acceptance threshold, Server sets the decision to “permit”; when the score is above a rejection threshold, Server sets the decision to “reject.” Server writes the decision and the aggregated risk score into the call-session record and outputs a decision object indicating the communication control action.

### Step 8:

Server generates and transmits a connection control signal to the communication apparatus according to the decision.

Server takes, as input, the decision object and the call identifier. When the decision is “permit”, Server constructs a signaling message that maintains or transitions the call to a ringing or connectable state. When the decision is “reject”, Server constructs a termination or refusal message that instructs the communication apparatus to end the call. Server encodes these messages in the appropriate signaling protocol, encapsulates them in network packets, and sends them through the network interface and optical communication element to the communication apparatus. Server updates the call-session record with the current connection state and outputs an updated connection status for use by subsequent steps.

### Step 9:

Server prepares and sends notification information to the terminal when the communication is permitted.

Server takes, as input, the decision object indicating permission, the safety evaluation object, and the call-session record. Server creates a notification payload that includes the identification information, the AI safety label, the AI explanation, and a representation of available user actions such as “answer” and “reject.” Server serializes this payload into a format accepted by the terminal's communication protocol and sends it to the terminal via a push-notification service or a persistent communication channel. Server records the notification time in the call-session record and outputs a notification status indicating that the terminal has been informed.

### Step 10:

Terminal receives the notification from the server and presents the AI evaluation to the user.

Terminal takes, as input, the notification payload arriving from the server through its communication module. Terminal parses the payload to extract the identification information, the AI safety label, and the explanation. Terminal stores these in local memory and triggers the user interface module to render an incoming-call screen. Terminal displays the caller identifier along with text such as “Screened: safe” or “Screened: dangerous” and shows the explanation. Terminal optionally activates audio and vibration hardware to alert the user. Terminal outputs a visible interface and internal state ready to accept a user response.

### Step 11:

User reviews the displayed information and selects a response option.

User takes, as input, the on-screen display showing the caller identifier and the AI evaluation results on the terminal. User interprets this information and decides whether to accept or reject the communication. User then touches an “Answer” button or a “Reject” button on the terminal's touchscreen, or takes another available action such as dismissing the notification. User's action produces a physical interaction signal that is captured by the terminal's input subsystem and results in a logical response command.

### Step 12:

Terminal sends the user's response operation back to the server.

Terminal takes, as input, the logical response command (for example, “answer” or “reject”) and the local representation of the call identifier. Terminal constructs a request message containing the call identifier and the response operation and transmits it to the server via the communication module. Terminal may wait for an acknowledgment, but from a data perspective, the output is a network message encoding the user's decision, which is received by the server as input for further control.

### Step 13:

Server updates the call state based on the user's response and controls final connection or termination.

Server takes, as input, the user response message indicating the user's action and the corresponding call identifier. Server retrieves the call-session record, updates a field representing the user response, and determines whether to establish or terminate the communication. When the user response is “answer” and the decision object indicated permission, Server generates a connect signal and sends it to the communication apparatus, enabling the voice path. When the user response is “reject”, Server generates a termination signal, even if the call was previously permitted. Server writes the final call state and timestamps to the storage device and outputs the updated call-session record for logging and analytics.

### Step 14:

Server records feedback information for future adjustment of thresholds and prompt sentences.

Server takes, as input, the final call-state data, the safety evaluation object, and the stored decision object. Server calculates outcome metrics, such as whether a “safe” call was answered or rejected, and whether a “dangerous” call was successfully blocked. Server appends these metrics to a feedback table in the database, incrementing counters and updating aggregate statistics for each identification information and for each prompt template. Server then optionally recalculates threshold values or selects alternative prompt templates for future use, based on mathematical operations over these statistics, such as moving averages or weighted scores. Server outputs updated configuration parameters and modified prompt templates, which will influence subsequent executions of Steps 4 through 7.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional call handling systems and contact management applications typically rely on static block lists, simple pattern matching, or rule-based filtering to identify unwanted or fraudulent communications. Such systems operate on limited feature sets (for example, only a caller number or a coarse reputation flag) and are not architected to integrate large-scale generative artificial intelligence models through structured prompt sentences. As a result, these systems provide only coarse-grained risk classifications, are prone to both false positives and false negatives, and cannot adaptively reflect evolving fraud patterns or nuanced user preferences.

Furthermore, in many existing architectures, any artificial intelligence processing that is used for spam or fraud detection is either tightly coupled to a specific classifier model or implemented as an opaque scoring service. The surrounding computer system does not structure and log the full interaction context (including caller metadata, user actions, and model outputs) in a way that can be fed back as training data. This leads to rigidity: the AI component is difficult to update or retrain, and the system cannot systematically improve its performance based on real-world usage. From a computer-technology perspective, this results in inefficient use of computational resources, duplicated logic for feature engineering, and fragmented data flows between telephony control, AI scoring, and user interface layers. Additionally, existing systems often do not provide a unified mechanism for using generative artificial intelligence models via explicit prompt sentences to perform multiple, heterogeneous tasks in the communication pipeline, such as (i) evaluating caller safety, (ii) generating control decisions for communication routing, (iii) interpreting user voice requests for reservations or orders, and (iv) adapting responses based on user emotional state. Instead, separate subsystems or services are introduced for each function, which increases system complexity, incurs extra network calls, and complicates logging and governance. Such fragmented designs hinder scalability, make it difficult to enforce consistent safety policies, and degrade system responsiveness.

From the standpoint of computer technology, there is a need for an improved system architecture and processing method in which a server-side processor coordinates telephony control, data storage, and interaction with a generative AI model through well-structured prompt sentences, while maintaining a closed feedback loop that reuses logged data for model retraining. Improving this coordination is not merely an automation of human tasks, but rather a restructuring of how the computing components themselves manage data representation, risk assessment, and communication control. The technical problem is to provide a system that (i) efficiently converts raw signaling data, historical logs, and user preferences into structured prompts for a generative AI model, (ii) deterministically interprets AI outputs for real-time call control and user notification, and (iii) persistently captures and reuses interaction data to improve the accuracy and robustness of the AI-driven call screening over time.

Moreover, existing voice-based reservation and ordering systems typically perform speech-to-text conversion and then rely on fixed templates or narrow-domain rule engines to construct outgoing communications. These approaches are brittle, require frequent manual updates, and do not generalize well across service providers or languages. They also generally do not use the same AI pipeline and logging mechanism as call-risk analysis, resulting in duplicated infrastructure and inconsistent behavior across functionalities. Accordingly, there is a need for a unified computer-implemented mechanism by which the same generative AI-oriented prompt framework can interpret user voice input, generate external communication instructions, and adapt its behavior based on user emotion and historical interaction data, thereby improving overall system efficiency, maintainability, and performance.

The specific processing by the specific processing unit 290 of the data processing device 12 in Application Example 1 is realized by the following means.

The present invention provides a server comprising a processor, a storage device, a communication interface, and a user terminal interface, wherein the processor is configured to execute computer-implemented operations that (i) receive incoming communication signals and extract caller identification information from signaling data via the communication interface, (ii) compare the caller identification information against contact data and user preference data stored in the storage device to identify unknown callers and compute risk evaluations based on associated history information and external evaluation information, (iii) construct structured data objects including the caller identification information, history information, user preference information, and risk evaluation results, embed the structured data objects into natural-language prompt sentences, and transmit the prompt sentences to a generative artificial intelligence model to obtain numerical safety scores and classification labels, (iv) apply deterministic threshold logic to the numerical safety scores and classification labels together with the user preference data to derive communication control policies that include at least blocking communications with high risk and holding low-risk callers in a standby state, (v) generate and transmit notification data to the user terminal so that the user terminal displays caller-related safety information, (vi) receive user selection data from the user terminal indicating permission, rejection, permanent rejection, or permanent permission of communications associated with the caller identification information, control communication paths according to the user selection data, and update allow lists and deny lists stored in the storage device, (vii) log caller identification information, risk evaluation results, generative AI model outputs, and user selection data as structured interaction records in the storage device and provide the structured interaction records as training data to retrain or update the generative AI model, (viii) perform voice recognition on user voice input to extract reservation requests and order requests, generate prompt sentences describing the extracted requests for the generative AI model, and, based on responses from the generative AI model, automatically initiate external communications to execute the reservations or orders, and (ix) analyze user voice input, user operation histories, and model outputs to estimate a user emotional state and generate further prompt sentences that cause the generative AI model to produce response content or service content adapted to the estimated emotional state. This enables a technically improved call-management and interaction system in which server-side components efficiently orchestrate telephony control, data storage, and generative AI processing through structured prompt sentences, thereby enhancing the accuracy and robustness of fraud-risk assessments, reducing misclassification of calls, unifying diverse AI-driven communication functions within a single architecture, and establishing a closed feedback loop that systematically improves model performance and overall system behavior over time.

The term “processor” refers to a hardware computation unit or a combination of hardware and firmware configured to execute machine-readable instructions, including a central processing unit, a microcontroller, or a programmable logic device.

The term “storage device” refers to a hardware memory component or subsystem, such as volatile memory or non-volatile memory, configured to store data, programs, configuration information, logs, lists, and model-related information used by the system.

The term “communication interface” refers to a hardware and software interface configured to send and receive data over a communication network, including interfaces for packet-based networks, circuit-switched networks, or short-range wireless links.

The term “user terminal” refers to an electronic device operated by a user, including a portable terminal, a fixed terminal, or a computing terminal, having at least a display device and an input interface for interacting with the system.

The term “incoming communication signal” refers to signaling information and, optionally, media information that indicate an attempt by an external communication endpoint to establish a communication session with the user terminal or the system.

The term “signaling data” refers to control information exchanged between communication endpoints or network elements for setting up, modifying, or terminating a communication session, including information such as caller identification information, call identifiers, and protocol headers.

The term “caller identification information” refers to data that identifies or is associated with a communication originator, including at least a communication address, a telephone number, or other identifier that can be used to distinguish one caller from another.

The term “contact information” refers to data stored in the storage device that associates identification information with attributes of entities, including names, communication addresses, classification information, and user-defined labels.

The term “user preference information” refers to configuration data specifying user choices or policies for handling communications, including allow or deny settings, threshold adjustments, notification preferences, and default actions.

The term “unknown caller” refers to a caller for which no corresponding contact record or explicit user preference entry is found in the storage device at the time of processing an incoming communication.

The term “history information” refers to data representing one or more past interactions related to a caller identification, including previous communication attempts, user actions, system decisions, and associated timestamps.

The term “external evaluation information” refers to information obtained from sources outside the system that indicates a reputation, risk score, or classification associated with a caller, such as third-party reputation data or external blacklists.

The term “risk evaluation” refers to a process in which the system determines or estimates a likelihood that a caller or communication is associated with undesirable behavior, such as fraud or solicitation, based on at least the caller identification information, history information, and external evaluation information.

The term “structured data” refers to data organized in a defined format, such as a record, array, or key-value structure, that represents attributes of a caller or an interaction in a form suitable for programmatic processing.

The term “prompt sentence” refers to a natural-language text or text-like expression constructed by the system that encodes one or more items of structured data and instructions, and is intended to be interpreted by a generative artificial intelligence model.

The term “generative artificial intelligence model” refers to a machine-learned model configured to generate outputs, including text, numerical values, or other data, in response to input prompts, by applying learned parameter weights and internal inference mechanisms.

The term “numerical score” refers to a quantitative value output by the generative artificial intelligence model that indicates at least a level of safety, risk, or suitability associated with a caller or communication.

The term “classification label” refers to a symbolic label, such as a categorical string or code, output by the generative artificial intelligence model, that indicates a classification result, including categories corresponding to degrees of safety or risk.

The term “safety of a caller” refers to a degree to which communications associated with the caller are considered benign or non-malicious, based on one or more risk evaluation criteria defined by the system.

The term “threshold information” refers to one or more values or conditions stored in the storage device and used by the processor to compare against numerical scores or other metrics in order to make decisions about communication control.

The term “communication control policy” refers to a set of rules or instructions derived by the processor based on at least numerical scores, classification labels, and user preference information, that specify how the system should handle a particular communication.

The term “standby state” refers to a communication state in which a caller is temporarily held without immediate connection to the user, including a state in which the caller is placed on hold or queued while the system awaits further decision.

The term “notification information” refers to data transmitted from the server to the user terminal that includes at least caller-related information, safety or risk indicators, and explanatory content for display to the user.

The term “warning information” refers to notification information that indicates a risk or potential undesirability associated with a caller or communication, and is intended to alert the user.

The term “safety information” refers to notification information that indicates that a caller or communication has been evaluated as having low risk or being likely legitimate.

The term “selection information” refers to data representing a choice made by the user through the user terminal, including commands to allow, reject, permanently allow, or permanently reject communications associated with a caller identification.

The term “communication path” refers to a logical or physical connection established between an external communication endpoint and the user terminal or system for the purpose of transmitting signaling or media data.

The term “allow list” refers to data stored in the storage device that specifies one or more caller identifications for which communications are to be permitted according to user preferences or system policy.

The term “deny list” refers to data stored in the storage device that specifies one or more caller identifications for which communications are to be blocked or rejected according to user preferences or system policy.

The term “log information” refers to stored records of operations or events within the system, including caller identification information, risk evaluation results, generative artificial intelligence model outputs, and user selection information.

The term “learning data” refers to data provided to a machine-learning process, including training data, fine-tuning data, or evaluation data, that is used to adjust parameters or behavior of the generative artificial intelligence model.

The term “voice input device” refers to a hardware component configured to capture sound produced by a user, such as a microphone or an array of microphones.

The term “voice data” refers to digital audio data derived from acoustic signals captured by a voice input device and representing speech or other sound produced by a user.

The term “voice recognition processing” refers to a computational process that converts voice data into text or structured representations of linguistic content, including automatic speech recognition operations.

The term “request content” refers to information extracted from voice data or other inputs that describes a desired action or service, including at least a reservation request or an order request.

The term “reservation request” refers to a request made by the user for the system to arrange an appointment, booking, or time-based allocation of a resource with an external entity.

The term “order request” refers to a request made by the user for the system to arrange acquisition of goods or services from an external entity.

The term “external communication” refers to a communication initiated by the system or under control of the system toward an endpoint outside the system, such as a remote server, service platform, or communication partner.

The term “operation history” refers to recorded data related to interactions between the user and the system, including user inputs, selections, confirmations, and timing information.

The term “emotional state” refers to an estimated state associated with the user's affect or sentiment, inferred by the system based on one or more of user voice data, operation history, and model outputs.

The term “response content” refers to information generated by or under control of the system for presentation to the user, including messages, prompts, or guidance that are adapted to the user's context or emotional state.

The term “service content” refers to actions or offerings generated or configured by the system for the user, including recommended services, options, or automated tasks tailored to user preferences and emotional state.

The term “communication conversion apparatus” refers to a hardware device that performs conversion between different physical or logical communication formats, including at least conversion between an optical signal and an electrical signal.

The term “control information” refers to data that specifies operating parameters or commands for controlling the behavior of a communication conversion apparatus or other communication-related hardware.

The term “control guidance” refers to information derived from the generative artificial intelligence model that indicates how a device or subsystem should be configured or controlled based on a corresponding prompt sentence.

The term “communication network” refers to any wired or wireless infrastructure through which data or signaling is transmitted between nodes, including public and private networks, packet-switched networks, and circuit-switched networks.

In one embodiment, a server executes a call-management application on top of an operating system such as a general-purpose server operating system. The server includes at least one processor, a main memory, a non-volatile storage device, a communication interface connected to a packet-based communication network, and interfaces to a telephony subsystem such as a private branch exchange implemented by software such as a software-based PBX or a softswitch. The server also communicates with at least one terminal operated by a user, for example a smartphone, a tablet, or a personal computer running a client application.

The server stores, in the storage device, several data structures: a contact table, a user preference table, an allow-list table, a deny-list table, a call-history table, and an interaction-log table. The contact table associates caller identification information (such as telephone numbers or network addresses, normalized into a canonical string format) with contact names and metadata. The user preference table stores user-specific rules, including risk thresholds, preferred warning levels, and default actions. The allow-list table and deny-list table each store normalized caller identifiers with associated flags. The call-history table stores per-call records, including timestamps, signaling information, numerical scores, and final outcomes. The interaction-log table stores detailed records of each interaction with a generative AI model, including prompt sentences, model outputs, and associated call identifiers.

The server implements a telephony integration module that interfaces with the telephony subsystem via a control protocol such as a session control API or an event socket. The telephony integration module receives low-level signaling messages that contain an incoming communication signal, extracts caller identification information (for example, from a signaling header or parameter field), and normalizes the identification into a standard internal representation such as an E.164-like string. The server then stores an initial record corresponding to the communication in the call-history table.

The server implements a caller-identification analysis module that accesses the contact table, the user preference table, the allow-list table, and the deny-list table. The server uses indexed queries on these tables to determine whether a caller is already known, whitelisted, or blacklisted. When the caller is not found in any contact or preference table, the server classifies the caller as an unknown caller. When the caller is found in the deny-list table, the server marks the communication as high risk without invoking a generative AI model. When the caller is found in the allow-list table, the server sets a low baseline risk level and may still invoke the generative AI model to refine the score.

The server implements a feature-construction module that prepares structured data for use by the generative AI model. The server aggregates multiple feature values such as: normalized caller identification information, country and region codes derived from the caller identifier, time-of-day and day-of-week, counts of previous communications from the same identifier in a recent window, ratios of allowed versus rejected outcomes for that identifier, user feedback labels recorded in prior interactions, and any external reputation scores retrieved from third-party reputation services. The server encodes these features into a key-value structure, for example an internal object representation, which is then transformed into a text representation embedded into a prompt sentence.

The server constructs a prompt sentence for a generative AI model using a template-based generator. The server uses different templates depending on context, such as real-time incoming communication analysis versus manual number analysis. For example, the server may generate a prompt sentence of the following kind:
“Analyze the fraud or solicitation risk for the following caller:
Phone number: +81-90-1234-5678
Call history: 3 previous calls rejected by users as ‘scam’.
User region: Japan.
Please return a risk score from 0.0 to 1.0, a label ‘safe’, ‘suspicious’, or ‘dangerous’, and a short explanation.”

In another example, the server may generate a prompt sentence:

“Evaluate the risk level of this phone number in the context of typical scam or solicitation calls.
Phone number: +81-3-1111-2222
Call history: 5 previous calls accepted, users marked as ‘delivery company’, no complaints.
Return a numeric risk score from 0 to 100 and a one-sentence explanation indicating whether this caller is likely legitimate.”

The server transmits such a prompt sentence to a generative AI model hosted on an AI platform. The generative AI model is, in one embodiment, a large language model built on a multi-layer transformer neural network architecture. The model includes an embedding layer that converts tokens of the prompt sentence into high-dimensional vectors, a sequence of self-attention and feed-forward layers with residual connections and normalization, and an output head that predicts probability distributions over tokens. The server configures the model endpoint with parameters such as maximum output length, temperature, and stopping criteria to favor deterministic structured outputs.

In one embodiment, the generative AI model is fine-tuned or instruction-tuned on domain-specific training data that includes examples of prompt sentences and desired outputs for fraud-risk analysis. The training procedure uses a supervised loss function such as cross-entropy between predicted token sequences and reference outputs, combined with additional regularization terms that encourage the model to respect requested output formats. During training, a gradient-based optimization algorithm such as Adam is used to update model weights, with mini-batch processing of training samples. The training data can be augmented with synthetic examples derived from real call logs, where caller identifiers are anonymized or hashed, and labels are derived from user feedback and existing rule-based heuristics.

The server parses outputs from the generative AI model. The output typically contains a risk score expressed as a numeric value and a label such as “safe”, “suspicious”, or “dangerous”, as well as a free-text explanation. The server implements a parser that scans the generated text for numerical patterns and label keywords using deterministic pattern-matching rules. The server normalizes the parsed risk score to a standard scale, for example mapping a 0-100 range to 0.0-1.0, and validates that the score is within expected bounds. When the parsing fails or the output appears inconsistent, the server applies fallback rules, such as assigning a default medium-risk score and flagging the analysis for logging.

The server uses a decision module to compute a communication control policy. The decision module applies threshold values stored in the user preference table. For example, the server may treat scores below a first threshold as low risk, between the first and a second threshold as medium risk, and above the second threshold as high risk. The decision module also takes into account membership in the allow-list and deny-list tables. When a caller is present in the deny-list table, the decision module overrides any low-risk score and treats the call as high risk. When a caller is present in the allow-list table, the module may lower the effective score or suppress certain warnings. This combination of model-derived scores and deterministic rule overrides provides a technical mechanism that stabilizes behavior and reduces variance compared to purely model-based or purely rule-based approaches.

The server sends information about the communication and its risk classification to the terminal. The server encapsulates the normalized caller identifier, the numerical risk score, the label, and a truncated explanation into a structured message and transmits it via a network protocol such as HTTPS or a persistent messaging channel such as a web socket. The terminal receives the message and uses a client application to update its user interface. The terminal may display, on a dedicated call-screening view, the caller identifier, a color-coded risk indicator, the label text, and a short warning or confirmation message. When the score is above the high-risk threshold, the terminal presents a warning phrase such as “High risk of fraud (score 0.88).” When the score is low, the terminal may show “Likely safe (score 0.05).” The terminal receives user input via a touch interface, keyboard, or pointing device. The terminal provides selectable options such as “Allow this call,” “Reject this call,” “Always allow this caller,” and “Always block this caller.” The terminal sends the user's selection information back to the server as a structured message that includes at least the call identifier, the caller identifier, and the selected action. The terminal can also provide an interface where the user manually requests analysis for a phone number outside of an active call. In that case, the terminal sends a manual-analysis request containing the target number and an optional free-text description such as “I received a suspicious SMS from this number.”

The server receives the user's selection information and updates the corresponding tables in the storage device. For a “Always allow” selection, the server inserts or updates a record in the allow-list table. For a “Always block” selection, the server inserts or updates a record in the deny-list table. The server also writes an interaction-log record that includes the original prompt sentence, the model output, the risk score, and the user's action. The server then sends commands back to the telephony subsystem to connect or disconnect the communication. For example, if the action is “Reject this call,” the server instructs the telephony subsystem to terminate the session by sending a corresponding call teardown message. If the action is “Allow this call,” the server instructs the telephony subsystem to bridge the external call leg with a user media leg associated with the terminal. This bridging results in actual connection or disconnection of media streams at the physical and link layers, thereby directly controlling real communication hardware.

The server also supports a “hold and transfer” function for calls deemed low risk. The server can place the incoming caller into a standby state by instructing the telephony subsystem to answer the network-side leg while not yet connecting it to the user. In this state, the telephony subsystem may play a pre-recorded message or an audio signal to the caller using audio files stored in the storage device and streamed via the telephony media engine. The server notifies the terminal that a trusted or low-risk caller is waiting and allows the user to initiate connection when convenient. When the user selects to connect, the server issues control commands to the telephony subsystem to bridge the media legs, thus converting the logical policy decision into a concrete hardware-level state change.

The server uses the interaction-log table as a source for improving the generative AI model. In a batch process, the server exports selected records that include caller features, prompt sentences, model outputs, user actions, and final outcomes. Before exporting, the server can apply anonymization rules, removing direct identifiers or hashing them. This exported dataset is used to fine-tune the generative AI model so that it better aligns its risk assessments with observed user behavior. The training system computes an error between the model's predicted scores or labels and target labels inferred from the user's actions. For example, if the user consistently rejects calls that the model labeled as “safe”, the training system adjusts the model parameters so that similar prompt contexts produce higher risk scores in subsequent usage. This closed-loop process provides a technical improvement in model calibration and reduces systematic misclassification over time.

The server additionally implements a voice-interpretation module to process user voice commands related to reservations and orders. The server receives voice data segments from the terminal or from a voice input device connected to the server and executes automatic speech recognition using a speech-recognition engine such as a neural acoustic model plus a language model. The acoustic model may be a recurrent neural network or transformer-based model that maps audio spectrogram frames to phoneme-like units, while the language model predicts sequences of words. The server converts the recognized text into structured request content, identifying entities such as dates, times, locations, and service types.

The server then constructs a prompt sentence that describes the user's request in a normalized form, including extracted parameters. For example, the server may form a prompt sentence:

“The user wishes to make a restaurant reservation.
Requested date: Apr. 12, 20XX
Requested time: 19:00
Number of people: 3
Preferred area: downtown.

Please generate the text of a communication to a reservation service to complete this booking.”

The server sends this prompt sentence to the generative AI model, receives a text output that contains a formatted communication or a set of steps to make the reservation, and either uses this output directly to generate an outgoing message or converts it to API calls for a reservation service. This approach allows the same generative AI model and prompt-sentence infrastructure to handle both risk-evaluation tasks and request-interpretation tasks without duplicating application logic.

The server further analyzes user voice data and operation histories to estimate user emotional state. The server may extract prosodic features such as pitch, speaking rate, and volume from the voice data and combine these with features derived from interaction patterns (for example, rapid rejection of multiple calls, frequent manual overrides, or sudden changes in risk tolerance). The server can use a separate neural classifier or a small generative model configured with classification prompts to estimate emotional categories such as “calm,” “frustrated,” or “anxious.” The server then constructs prompt sentences for the generative AI model that instruct it to tailor response content according to the estimated emotional state, such as providing more detailed reassurance when the user appears anxious or simpler prompts when the user appears busy.

By structuring the data flow in this way, the system improves core aspects of computer operation. The use of normalized caller identifiers and structured feature vectors reduces redundancy and enables more efficient indexing and caching in the storage device. The threshold-based decision module coupled with allow-list and deny-list overrides reduces the number of unnecessary calls to the generative AI model, thereby decreasing network load and inference latency. The template-based prompt generator ensures that the generative AI model receives consistently formatted context, which increases the reliability of parsing and reduces error-handling overhead. The logging and feedback loop allow the system to automatically adjust to new patterns without manual reprogramming, improving the accuracy and responsiveness over time.

The server's control of the telephony subsystem and communication conversion equipment also ties the abstract scoring process to concrete hardware actions. Because the server's decisions directly control call establishment, hold, and tear-down at the signaling layer, the improvement in the scoring algorithm leads to measurable technical effects: fewer unnecessary call setups, shorter ring durations for calls that are ultimately rejected, reduced bandwidth consumption, and lower processing load on telephony hardware. In particular, by accurately distinguishing high-risk callers earlier, the server can instruct the telephony subsystem to reject these calls before media channels are fully established, reducing media-path resource usage.

The server employs a generative AI model not simply as a replacement for human decision-making but as an integrated computational component that optimizes data representation and decision-making in the communication pipeline. The use of explicit prompt sentences and deterministic post-processing transforms a free-form generative system into a predictable, machine-coordinated module that operates under well-defined constraints. This architecture improves calculation efficiency, facilitates parallelization of AI calls, and enables the system to allocate computing resources based on call volume and risk levels. As a result, the combination of hardware components, software modules, data structures, and AI processing described above forms an implementation that can be practiced by an ordinary person skilled in computer and communication technologies, and that yields concrete technical advantages in call screening, communication routing, and user interaction.

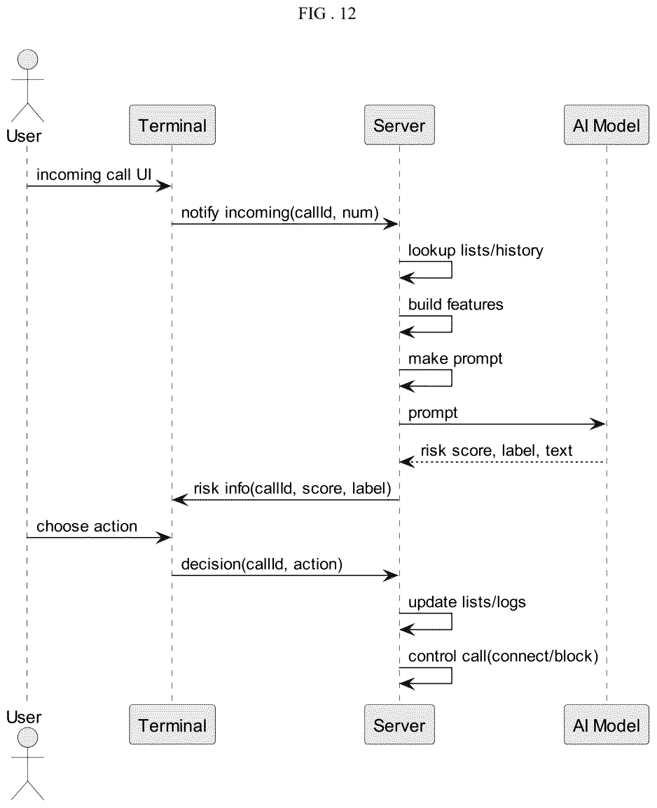

The following describes the processing flow using FIG. 12.

### Step 1:

Server receives an incoming communication signal from a telephony subsystem and extracts caller identification information. The input is low-level signaling data (for example, a call setup message containing a caller address or telephone number). Server parses protocol headers and parameters, normalizes the caller identifier into a canonical string format, and generates an internal call identifier. The output is a structured record containing the call identifier and normalized caller identification information.

### Step 2:

Server determines whether the caller is known, whitelisted, or blacklisted by querying stored tables. The input is the normalized caller identification information from Step 1 and database contents including a contact table, an allow-list table, and a deny-list table. Server executes indexed lookups to compare the caller identifier with stored entries and evaluates matching rules. The output is a classification flag (for example, “known,” “unknown,” “allow-listed,” or “deny-listed”) and any associated contact metadata.

### Step 3:

Server computes preliminary risk indicators based on call history and external reputation information. The input is the caller classification flag from Step 2, the caller identification information, and records in a call-history table and external reputation data sources. Server aggregates features such as number of past calls, ratio of accepted to rejected calls, timestamps, and any external risk scores. Server performs arithmetic operations (counts, ratios, time-window filtering) to derive intermediate risk metrics. The output is a feature set and a preliminary risk value associated with the caller.

### Step 4:

Server constructs a structured feature object representing the caller context for AI analysis.

The input is the feature set and preliminary risk value from Step 3, together with user preference data such as user-defined thresholds or regional settings. Server encodes these values into a key-value structure and serializes them into a human-readable form, such as labeled lines of text. The output is a structured feature object and its textual representation ready to be embedded into a prompt sentence.

### Step 5:

Server generates a prompt sentence for a generative AI model by embedding the textual representation of the feature object into a natural-language template. The input is the textual feature representation from Step 4 and a template specifying the required response format. Server concatenates static template text with dynamic feature text, inserts explicit instructions for output format, and ensures that fields such as “risk_score” and “label” are clearly requested. The output is a complete prompt sentence, for example:

“Analyze the fraud or solicitation risk for the following caller:
Phone number: +81-90-1234-5678
Call history: 3 previous calls rejected by users as ‘scam’.
User region: Japan.
Please return a risk score from 0.0 to 1.0, a label ‘safe’, ‘suspicious’, or ‘dangerous’, and a short explanation.”

### Step 6:

Server sends the prompt sentence to the generative AI model and obtains a textual response.

The input is the prompt sentence from Step 5 and configuration parameters such as maximum output length and temperature. Server transmits the prompt via an API call, waits for the response, and receives generated text that includes a numerical score, a classification label, and an explanation. The output is the raw AI response text.

### Step 7:

Server parses the AI response text to extract a normalized risk score, a label, and an explanation. The input is the raw AI response text from Step 6. Server applies pattern-matching rules and numeric parsing to locate the risk value, validates that the value falls within an expected range, and maps textual labels (for example, “SAFE,” “suspicious”) to standard internal labels. The output is a normalized numerical risk score (for example, a floating-point value between 0.0 and 1.0), a standardized label, and a cleaned explanation string.

### Step 8:

Server computes a final risk classification and a communication control policy using the normalized score, the label, and user preferences. The input is the normalized risk score and label from Step 7, the preliminary risk value from Step 3, and user preference thresholds. Server compares the score to low and high thresholds, applies rule-based overrides for allow-listed and deny-listed callers, and combines intermediate values using conditional logic (for example, max or weighted average). The output is a final risk category (for example, “low,” “medium,” “high”) and a communication control policy specifying actions such as “block,” “hold,” or “ring with warning.”

### Step 9:

Server prepares notification information for the terminal based on the communication control policy. The input is the final risk category and communication control policy from Step 8, the caller identification information, and the explanation string. Server assembles a notification payload that includes the caller identifier, the risk score, the label, the risk category, and a short text message for the user. Server formats the payload for transmission (for example, as a JSON object or serialized message). The output is a notification payload ready to be sent to the terminal.

### Step 10:

Terminal receives the notification payload and updates the user interface to present the call-screening result. The input is the notification payload from Step 9. Terminal parses the payload, maps the risk category to UI elements such as colors or icons, and composes display text showing the caller identifier, the risk score, and the explanation. Terminal calls native display APIs to render a call-screening screen or overlay. The output is a visual presentation on the terminal's display device, such as a banner stating “High risk of fraud (score 0.88).”

### Step 11:

User observes the displayed information and selects an action for the incoming communication. The input is the visual presentation from Step 10. User interprets the caller identifier and warning or safety message and chooses an option such as “Allow,” “Reject,” “Always allow,” or “Always block” by interacting with touch controls, buttons, or other input methods on the terminal. The output is a user decision encoded as an action selection at the terminal.

### Step 12:

Terminal transmits the user's decision to the server. The input is the action selection from Step 11 and contextual identifiers such as the call identifier and caller identifier. Terminal constructs a decision message containing the selected action and identifiers, and sends the message to the server via a network protocol. The output is a decision payload delivered to the server.

### Step 13:

Server processes the user's decision to control the communication path. The input is the decision payload from Step 12, the communication control policy from Step 8, and the current state of the communication at the telephony subsystem. Server interprets the decision (for example, “Reject” or “Allow”), issues control commands to the telephony subsystem (for example, to hang up, to answer, or to bridge media streams), and updates internal state flags. The output is a new communication state, such as “connected,” “disconnected,” or “on hold,” applied at the telephony layer.

### Step 14:

Server updates allow-list and deny-list tables based on persistent user decisions. The input is the user's action from Step 12 and the caller identification information. Server checks whether the action indicates a permanent preference (for example, “Always allow” or “Always block”), and if so, inserts or updates records in the allow-list or deny-list table using database operations. The output is an updated preference database that will influence future risk evaluations and control policies.

### Step 15:

Server records interaction logs for AI feedback and auditing. The input is the caller identification information, the prompt sentence from Step 5, the AI response text from Step 6, the normalized risk score and label from Step 7, the communication control policy from Step 8, and the user decision from Step 12. Server writes a structured log entry containing these fields into an interaction-log table. The output is a persistent log record that can be used later for model evaluation, debugging, and retraining.

### Step 16:

Server prepares training data for improving the generative AI model using accumulated logs. The input is a collection of interaction-log records from Step 15 over a defined time window. Server filters the records, anonymizes caller identifiers as needed (for example, by hashing), and derives target labels from user actions and final outcomes. Server converts each record into a training sample that pairs a prompt sentence with a desired textual response or target risk score. The output is a training dataset formatted for use by a model-training pipeline.

### Step 17:

Server handles manual analysis requests for specific caller identifiers without an active call. The input is a request from the terminal containing a target caller identifier and optional user description text. Server constructs a feature object similarly to Step 4 but without current-call context, generates a specialized prompt sentence such as “The user wants to know if this phone number may be involved in fraud or solicitation,” and sends it to the generative AI model as in Steps 5 and 6. The output is a risk assessment and explanation that the server returns to the terminal for display.

### Step 18:

Server processes user voice data for reservation or order requests. The input is voice data segments received from the terminal or a voice input device. Server runs voice recognition processing to convert the audio into text, then applies natural-language parsing to extract structured fields such as dates, times, locations, and item names. Server uses these fields to generate a prompt sentence, for example:

“The user wishes to make a restaurant reservation.
Requested date: Apr. 12, 20XX
Requested time: 19:00
Number of people: 3
Preferred area: downtown.

Please generate the text of a communication to a reservation service to complete this booking.”

The output is a structured request object and a corresponding prompt sentence for the generative AI model.

### Step 19:

Server retrieves and uses generative AI model output to drive external reservation or order communications. The input is the prompt sentence from Step 18 and the model's textual response. Server parses the response to extract actionable content, such as a formatted message or explicit steps to contact an external service. Server may convert this content into an outgoing message or structured API calls and sends them via the communication interface. The output is an initiated external communication that performs the reservation or order requested by the user.

### Step 20:

Server estimates user emotional state to tailor system responses. The input is user voice features (such as pitch and speaking rate), operation history data (such as frequent rejections), and recent AI outputs. Server computes numerical descriptors of the voice signal, aggregates them with interaction statistics, and applies a classification algorithm or an additional generative AI prompt to infer an emotional category. Server then generates a modified prompt sentence for subsequent interactions, instructing the generative AI model to adopt a tone and detail level appropriate to the inferred emotional state. The output is an adapted response strategy that influences how risk information, reservations, or other communications are presented to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented reservation and ordering systems typically process user requests through rigid rule-based pipelines. In many cases, such systems either rely solely on simple keyword matching of text, or require the user to manually navigate graphical user interfaces and input structured data. As a result, when users issue natural, unstructured voice commands, the underlying computing system often fails to correctly infer the user's true intent and associated parameters, such as time, place, type of service, or number of participants. This leads to misinterpretation of requests, frequent need for manual correction, and increased processing overhead at the application layer.

Moreover, existing telecommunication control systems do not tightly integrate generative artificial intelligence models into the core of the call control logic. In typical architectures, any large language model or generative model is treated as an auxiliary component that merely generates free-form text. The results then must be post-processed by additional ad hoc parsing code. This separation introduces latency, code complexity, and failure modes where the generated output is not suitable for direct machine consumption, thereby degrading the efficiency and reliability of the reservation or ordering workflow executed by the processor. In addition, known systems generally lack robust mechanisms for dynamically adapting communication flows and service behaviors based on an estimated emotional state of the user. Many systems deliver the same static response irrespective of whether the user is calm, frustrated, or anxious, resulting in poor user experience and inefficient interaction loops. Emotional cues present in the user's voice or in the conversation context are not systematically exploited by the computing architecture to modify prompts, service selection, or notification content.

Further, when the reservation or ordering involves telephony or other communication channels, conventional systems frequently require separate subsystems to perform contact lookup, call routing, and call control. The intent determination, database lookup, and communication control are not orchestrated under a unified processor configuration. This fragmented architecture increases integration costs, complicates error handling, and impedes optimization of end-to-end performance, such as reducing the number of round-trips between the application server, the database, and the communication service.

There is also a technical limitation in that many existing solutions are hard-coded for specific domains or providers and cannot flexibly adapt to different communication paths, including optical communications and other heterogeneous network interfaces. Systems are not configured to parameterize communication paths within prompts fed to generative models and therefore cannot readily instruct the underlying network layer to use a particular route or medium when performing automatic outgoing communication. This reduces the extensibility and scalability of the communication control performed by the processor.

Accordingly, there is a need for an improved computer-implemented system that integrates speech recognition, generative artificial intelligence models, structured command extraction, database-driven contact resolution, automatic communication control, and user emotion estimation into a unified processing architecture. Such a system should reduce the amount of handcrafted parsing logic, improve the accuracy and robustness of intent and parameter extraction, optimize the sequence of database and communication operations, and dynamically adapt interaction flows and notifications based on the user's emotional state, thereby improving the functioning of the computer system itself in executing complex, voice-driven reservation and ordering tasks.

The specific processing by the specific processing unit 290 of the data processing device 12 in Example 2 is realized by the following means.

The present invention provides a server comprising a processor configured to receive a communication signal, extract source information from the communication signal, and perform risk evaluation for a source of the communication signal by collating the source information with stored information; convert a voice signal acquired from a voice input device into character information by performing speech recognition processing, and analyze a request content of a user from the character information; generate a prompt sentence including the request content of the user, input the prompt sentence to a generative information processing model, and acquire structured information including an intention and parameters corresponding to the request content from the generative information processing model; search an information storage device based on the structured information and acquire contact information of a transportation means or a facility; control an outgoing process by using a communication service having a communication function so as to automatically establish a communication connection to the acquired contact information and perform arrangement of the transportation means or reservation of the facility; estimate an emotional state of the user based on at least one of an output of the generative information processing model and the voice signal, and select response content or service content to be provided according to the emotional state; and generate notification information indicating a result of the arrangement of the transportation means or the reservation of the facility and cause a terminal device to present the notification information to the user. This enables the server to implement, within a single processor-controlled architecture, an improved end-to-end pipeline that transforms unstructured voice input into structured machine-actionable commands using a generative AI model, coordinates efficient database lookups and automated communication control, and dynamically adapts responses and service execution based on user emotion, thereby enhancing the accuracy, robustness, and performance of computer-based reservation and ordering operations.

The term “processor” refers to a hardware computation unit, or a set of hardware computation units, configured to execute machine-readable instructions and perform logical, arithmetic, and control operations required to implement functions of the system.

The term “communication signal” refers to an electrical or electromagnetic signal transmitted via a communication medium and representing information exchanged between an external communication endpoint and the system.

The term “source information” refers to information indicating an origin of a communication signal, including at least one of an address, an identifier, or metadata associated with a transmitting endpoint.

The term “stored information” refers to information retained in a storage device, including but not limited to records for risk evaluation, contact data, user profiles, or communication history.

The term “risk evaluation” refers to a process of determining a likelihood that a source of a communication signal is associated with an undesired event, such as fraud, spam, or malicious activity, based on comparison of source information with stored information.

The term “voice signal” refers to an analog or digital signal obtained from a user's spoken utterance via a voice input device.

The term “voice input device” refers to an apparatus configured to acquire sound, including a microphone or a microphone array, and convert the sound into a corresponding electrical signal.

The term “speech recognition processing” refers to a computational procedure that analyzes a voice signal and generates character information representing a textual transcription of the spoken content.

The term “character information” refers to data representing text, encoded in a character set, that is generated as a result of speech recognition processing or other text acquisition.

The term “request content of a user” refers to semantic information indicating what the user desires the system to perform, including at least an action type and, optionally, associated parameters.

The term “prompt sentence” refers to a text sequence constructed to be input to a generative information processing model, the text sequence explicitly or implicitly describing a task, a user request, conditions, or output requirements.

The term “generative information processing model” refers to a computer-implemented model, such as a generative AI model or a large language model, configured to generate output data based on input data by predicting sequences, completing patterns, or transforming representations.

The term “structured information” refers to data organized according to a predefined format, such as a set of key-value pairs, a schema, or a data structure, enabling direct machine interpretation and processing.

The term “intention” refers to a representation of a logical purpose or action requested by the user, such as an instruction to perform a reservation, an order, or another operation.

The term “parameter” refers to a value associated with an intention that specifies details of the requested operation, including but not limited to a time, a location, a quantity, or a category.

The term “information storage device” refers to a physical or virtual storage resource, such as a database system or a file system, configured to store and provide access to information used by the processor.

The term “contact information” refers to information used to initiate communication with an external entity, including at least one of a telephone number, a network address, or an identifier associated with a communication endpoint.

The term “transportation means” refers to a transportation service or transportation provider, such as a vehicle dispatch service or public transportation provider, that may be arranged or requested by the system.

The term “facility” refers to a service-providing establishment, including but not limited to a restaurant, accommodation, or event venue, for which a reservation can be made.

The term “communication service” refers to a service or platform providing connectivity functions for establishing, managing, or terminating communication sessions between endpoints.

The term “communication function” refers to a capability of transmitting and receiving communication signals over a communication network and controlling parameters of communication sessions.

The term “outgoing process” refers to a sequence of operations executed by the processor to initiate communication from the system toward an external destination using a communication service.

The term “communication connection” refers to a logical or physical link established between the system and an external endpoint through which communication signals are exchanged.

The term “arrangement of the transportation means” refers to a process of requesting and confirming provision of a transportation service for a user based on determined intention and parameters.

The term “reservation of the facility” refers to a process of requesting and confirming allocation of resources or time slots at a facility for a user based on determined intention and parameters.

The term “emotional state of the user” refers to an estimated psychological condition of the user, such as calmness, frustration, satisfaction, or urgency, inferred from available data.

The term “response content” refers to information generated by the system to be presented to the user in reaction to the user's request, including explanatory messages, confirmations, or recommendations.

The term “service content” refers to a configuration or selection of services to be provided to the user, including choices of provider, timing, or interaction style, determined by the processor.

The term “notification information” refers to information indicating a status, result, or progress of an operation performed by the system, formatted for presentation to the user.

The term “terminal device” refers to an information processing apparatus, such as a mobile device, a tablet, or a personal computer, configured to interact with the user and communicate with the server.

The term “reservation or order” refers to a request by the user to obtain a service or a product at a specified or inferred time, place, or condition.

The term “input information” refers to data constructed by the processor and supplied to the generative information processing model, the data including at least one prompt sentence and optionally additional condition information.

The term “item information required for the request” refers to specification data indicating data fields or parameters necessary to fulfill a user request, such as date, time, quantity, or category.

The term “condition information specifying an output format” refers to information that constrains or defines how the generative information processing model should structure its output, including formatting rules and schema descriptions.

The term “automatic outgoing process” refers to a process in which the processor initiates and controls communication without manual dialing by the user, based on structured information.

The term “communication device capable of transmitting and receiving an optical signal” refers to hardware configured to send and receive signals encoded as optical radiation for communication purposes.

The term “optical signal” refers to a modulated light-based signal that carries information through an optical medium.

The term “electric signal” refers to an electrical representation of information produced by conversion from an optical signal or other physical signal.

The term “communication network” refers to an interconnected system of communication links and nodes that enables exchange of communication signals between endpoints.

The term “communication path via the optical signal” refers to a communication route that includes at least one segment where information is conveyed using an optical signal.

The term “condition information relating to a communication path” refers to data describing constraints, preferences, or requirements for selecting or using a communication path, including a path involving optical communication.

In one embodiment, a server cooperates with one or more terminals used by a user to provide automatic arrangement of transportation means and reservation of facilities based on voice input. The server includes a processor, a memory, a network interface, and one or more storage devices. The terminal includes a processor, a memory, a microphone as a voice input device, a speaker, and a display unit. The user interacts with the system mainly through the terminal.

The terminal uses its microphone and an audio codec to convert an analog voice signal generated by the user into digital audio data. The terminal uses an operating system audio library, such as an audio capture framework on a mobile operating system, to perform sampling (for example, 16 kHz, 16-bit PCM), buffering, and optional noise suppression and echo cancellation. The terminal then uses speech recognition software, such as a speech recognition application programming interface (API) provided as part of a cloud platform or an on-device speech recognition library, to convert the digital audio data into character information representing the user's utterance. The terminal encodes the text as a character string, for example in UTF-8 format, and transmits the text to the server via a network protocol such as Hypertext Transfer Protocol Secure (HTTPS) or a WebSocket-based protocol.

The server receives the character information through the network interface and stores it in memory as part of a request object. The server may also associate the character information with metadata such as a user identifier, a timestamp, a language code, and an approximate location received from the terminal. The server then generates a prompt sentence for a generative AI model. The server constructs the prompt sentence by embedding the user's utterance and associated metadata into a predefined template. For example, the server may generate a prompt sentence such as:
“The user said: ‘Call me a taxi.’ Analyze this sentence, determine the user's intent and required parameters (pickup location, pickup time, number of passengers), and output the intent name and the parameters.”
or
“The user said: ‘Book a nearby Italian restaurant for two people at 7 PM.’ Analyze this request, identify the intent (restaurant reservation), and extract the cuisine type, number of people, and reservation time as parameters.”

The server uses a generative AI model implemented as a neural network that processes tokenized text. In one embodiment, the server uses a transformer-based architecture comprising an input embedding layer, a plurality of self-attention layers, feed-forward layers, and an output projection layer. The server tokenizes the prompt sentence using a subword tokenizer, converts tokens into embedding vectors, and feeds the sequence into the transformer model. The model has been trained in advance on large-scale textual data to learn probability distributions over token sequences and has been further fine-tuned on domain-specific data that associates natural language instructions with structured labels such as intent types and parameter fields.

The server executes the generative AI model either locally on a graphics processing unit (GPU) cluster with software frameworks such as a numerical computation library or via an external generative AI service accessed by a model API. The server configures model parameters such as decoding temperature, maximum output length, and output style to favor deterministic, schema-like responses. Instead of free-form narrative output, the server instructs the model to generate compact, machine-readable phrases such as:
“Intent: call_taxi; Pickup_location: user_current_location; Pickup_time: now.”
or
“Intent: reserve_restaurant; Cuisine: Italian; People: 2; Time: 19:00; Location: near_user.”

By using a transformer model with attention mechanisms, the server enables the model to capture long-range dependencies in the user's utterance and context, which improves the accuracy of intent detection and parameter extraction compared to simple keyword-based or rule-based parsing. The server uses specific tokens and delimiters in the prompt sentence to make the boundary between instructions and user input explicit, thereby reducing ambiguity and improving parsing robustness.

The server parses the output of the generative AI model using a deterministic parser that splits the output into fields based on predefined separators (for example, a colon and semicolons). The server validates the extracted fields against a schema that defines required parameters for each intent. For example, for a “call_taxi” intent, the server checks that a pickup time and a pickup location are present; if any required parameter is missing, the server can infer default values or initiate a follow-up interaction with the user through the terminal. The server represents the intent and parameters in an internal structured data object such as a dictionary with keys “intent_type”, “time”, “place”, and “quantity”.

The server then performs a database search using the structured information. The server connects to an information storage device that may be implemented as a relational database management system or a document-oriented database. The database stores contact information for transportation means and facilities, including service provider identifiers, areas of coverage, telephone numbers, operating hours, and historical performance indicators. The server constructs a query based on the intent and parameters. For a transportation arrangement, the server may restrict results to providers serving the user's region and available at the requested time. For a facility reservation, the server may search facilities matching a specified category, such as cuisine type, within a distance threshold from the user's location.

The server applies ranking logic to the query results using a scoring function that may consider estimated travel time, rating scores, success rate of previous reservations, or load balancing constraints. By performing the query and ranking using structured parameters derived from the generative AI model, the server reduces ambiguous mappings and improves both retrieval speed and accuracy compared with manual or heuristic-based search.

After selecting an appropriate provider, the server uses a communication service to initiate an outgoing communication. In one embodiment, the server uses an application programming interface of a telephony platform that can establish voice calls over a communication network. The server supplies the destination telephone number, caller identification, and call control instructions to the communication service. The server may also generate a voice prompt to be played during the call by using a text-to-speech engine. For example, the server can generate a text message such as “Please dispatch a vehicle to [address] for [user name] as soon as possible” or “Please reserve a table for two at 7:00 PM.” The server then sends this text to a text-to-speech module that synthesizes an audio waveform according to a neural vocoder or concatenative synthesis algorithm. The communication service plays this synthesized audio to the provider's line, and the provider's system or operator confirms the reservation or arrangement.

In another embodiment, the server controls a communication device capable of transmitting and receiving optical signals, such as an optical transceiver. The server configures the communication path by converting optical signals received through an optical interface into electrical signals and routing them into a packet-based communication network. The server can include, in the prompt sentence supplied to the generative AI model, condition information indicating a preference or requirement for using an optical communication path, such as “Use the optical backbone link for this communication if available.” The generative AI model can then return a recommendation or parameter that causes the server to select a specific communication route. This use of prompt-level control over communication paths allows the server to dynamically balance network load and reduce latency for certain classes of reservations.

The server further estimates an emotional state of the user by analyzing acoustic features of the voice signal and textual cues from the user's utterance. The terminal, during audio capture, may compute prosodic features such as pitch, energy, speaking rate, and spectral characteristics using a digital signal processing library and send summary features to the server. The server can also apply a separate neural classifier, such as a recurrent neural network or a transformer trained for sentiment and emotion detection, to the recognized text. The server combines these features in an emotion estimation module that outputs labels such as “calm”, “frustrated”, or “urgent”, together with a confidence score.

The server uses the estimated emotional state to adjust prompt sentences and system behavior. For example, if the user appears frustrated, the server can include additional instructions in the prompt sentence such as “The user seems frustrated; generate a concise and highly reliable extraction of intent and parameters.” This causes the generative AI model to bias toward conservative interpretations, reducing the risk of errors. The server can also select a different set of candidate providers, prioritize faster response times over cost, or modify the wording and modality of notification messages. This dynamic adaptation reduces the number of corrective interactions and improves overall system throughput.

From a technical standpoint, the server's use of the generative AI model and prompt sentences is configured to improve computer processing rather than simply automating human decision-making. The server uses the model not only for free-form generation but as a structured command extractor with constraints encoded in the prompt and in the parser. The server defines a specific data flow: (i) conversion of voice to text, (ii) construction of a constrained prompt sentence, (iii) generation of a structured representation of intent and parameters, (iv) deterministic parsing and validation, (v) database query formulation based on structured parameters, and (vi) controlled activation of a communication device. This architecture reduces the need for complex, handcrafted rule sets and decision trees that would otherwise be required to interpret unstructured user utterances, thereby reducing code size and maintenance overhead.

In one training method, the generative AI model is fine-tuned with a dataset of pairs of prompt sentences and target structured outputs. The server or an offline training system computes a loss function, such as cross-entropy over token sequences, between the model's output and the target sequence that encodes intent and parameters. The system updates model weights using a gradient-based optimization algorithm, such as stochastic gradient descent with adaptive learning rates. Data augmentation techniques can be applied by paraphrasing user utterances, adding noise to time expressions, or varying parameter order, which improves robustness to variations in real-world speech input. As a result, during deployment, the server obtains more accurate and stable structured outputs for a wide variety of request sentences, which in turn improves the success rate of automatic reservations and reduces misrouted calls.

The server's integration of risk evaluation for incoming communication signals provides additional technical benefit. By maintaining a database of known risk patterns, such as suspicious caller identifiers and historical failure outcomes, the server can evaluate new communication signals and determine whether to proceed with certain automatic actions or require additional verification. This evaluation uses hash-based indexing and pattern-matching algorithms that operate efficiently on large volumes of historical data.

Consequently, the system reduces the risk of misuse of the automatic outgoing process and decreases the computational burden of handling fraudulent or spam communications.

The terminal presents notification information generated by the server to the user through the display and, optionally, through synthesized speech. The notification information includes details of the arranged transportation means or reserved facility, such as provider name, scheduled time, and reference numbers. The terminal may store these notifications locally along with timestamps in a history list. By structuring notification data and associating it with the underlying intent and parameters, the server and terminal can support efficient retrieval and display of past transactions without re-querying the external communication service. Different embodiments can use different hardware and software configurations. In one variation, the speech recognition processing is fully executed on the terminal, reducing network bandwidth usage by transmitting only text to the server. In another variation, raw or compressed audio is transmitted to the server, and the server performs speech recognition using a dedicated speech recognition engine optimized for the specific domain. In some embodiments, the generative AI model is hosted by a third-party model service accessed through an API; in other embodiments, the model executes locally on the server cluster for reduced latency and improved control over training and updates.

In another embodiment, the system uses multiple generative AI models specialized for different task categories. The server can first run a lightweight classifier to select an appropriate model based on the domain of the user's request (for example, transportation, dining, accommodation). The server then constructs a domain-specific prompt sentence tailored to the selected model. This modular approach allows the system to scale to new service domains without redesigning the entire interpretation pipeline and further improves computational efficiency by avoiding the use of overly large general-purpose models for simple requests.

By tightly combining the generative AI model with well-defined prompt sentences, deterministic parsing, structured database queries, and explicit control over communication devices, the system achieves improvements in processing speed, accuracy, and resource utilization. The server reduces the number of network round-trips by directly deriving parameters suitable for call setup in a single model invocation, instead of performing multiple clarification steps or manual operator interventions. The server reduces communication load by avoiding unnecessary retries and misdirected calls that would otherwise occur when intent and parameters are misinterpreted. These technical effects arise from the particular configuration of the generative AI model as a structured command generator, the design of prompt sentences, and the subsequent processing pipeline, rather than from automation of a generic reservation procedure.

Because the server and terminal implement the described algorithms and data flows, another person skilled in the art can realize the invention by providing compatible processors, storage devices, communication interfaces, and software modules for speech recognition, generative AI inference, database access, risk evaluation, emotion estimation, and telecommunication control, all operating in the coordinated manner described above.

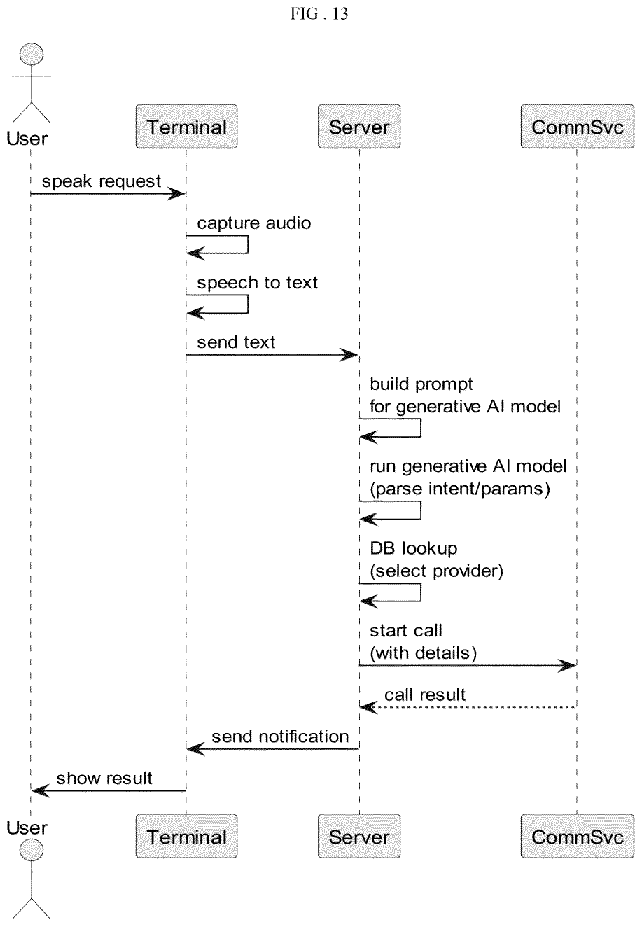

The following describes the processing flow using FIG. 13.

### Step 1:

The user speaks a request toward the terminal.

The user provides a voice input, such as “Call me a taxi” or “Book a nearby Italian restaurant for two people at 7 PM.”

The input is an analog voice signal generated by the user's speech, and the output is acoustic pressure waves in the vicinity of the terminal's microphone.

### Step 2:

The terminal captures and digitizes the voice signal.

The terminal uses a microphone and an audio codec to sample the analog voice signal at a predetermined sampling rate (for example, 16 kHz, 16-bit) and buffers the resulting digital samples in memory.

The terminal may apply pre-processing operations, such as noise suppression and voice activity detection, using an audio processing library.

The input is the analog voice signal from the user, and the output is a sequence of digital audio frames representing the utterance.

### Step 3:

The terminal converts the digital audio into text by speech recognition.

The terminal sends the digital audio frames to a speech recognition API or executes an on-device recognizer, which performs feature extraction (for example, Mel-frequency cepstral coefficients), acoustic modeling, and language modeling to infer the most probable character sequence corresponding to the speech.

The terminal receives a transcription result and encodes it as character information (for example, a UTF-8 text string).

The input is the sequence of digital audio frames, and the output is the recognized text, such as “Call me a taxi.”

### Step 4:

The terminal transmits the recognized text and metadata to the server.

The terminal packages the text together with metadata such as a user identifier, timestamp, language code, and, optionally, a location value into a structured request, and sends it to the server via a secure network protocol.

The terminal performs serialization (for example, building a message body) and network transmission using a communication library.

The input is the recognized text and local metadata, and the output is a network message delivered to the server.

### Step 5:

The server receives the request and stores the request data.

The server parses the incoming message, verifies authentication tokens, and extracts the text, user identifier, and other metadata fields.

The server allocates a request object in memory and stores the fields for subsequent processing.

The input is the network message from the terminal, and the output is an in-memory request object containing the user utterance and associated context.

### Step 6:

The server constructs a prompt sentence for the generative AI model.

The server selects a prompt template according to the type of service (for example, transportation arrangement or facility reservation) and inserts the user's text and context parameters into the template.

The server may append explicit instructions regarding output structure, such as required intent names and parameter types.

For example, the server may construct a prompt sentence:

“The user said: ‘Call me a taxi.’ Analyze this sentence, determine the user's intent and required parameters (pickup location, pickup time, number of passengers), and output the intent name and the parameters.”

The input is the request object containing the recognized text and context, and the output is a fully formed prompt sentence ready for model inference.

### Step 7:

The server tokenizes the prompt sentence and prepares model input.

The server uses a tokenizer associated with the generative AI model to divide the prompt sentence into tokens, maps each token to a numerical identifier, and generates a sequence of token IDs.

The server may truncate or pad the sequence to a model-specific length and organizes the sequence into tensors for input to the model.

The input is the plain-text prompt sentence, and the output is a tokenized representation in numerical form suitable for the generative AI model.

### Step 8:

The server executes the generative AI model and obtains a structured output string.

The server feeds the token sequence to a generative AI model, such as a transformer-based language model executing on an accelerator device or accessed via a model inference API. The server performs forward propagation through embedding layers, attention layers, and feed-forward layers to compute output token probabilities and decodes them according to predetermined parameters (for example, greedy decoding with low temperature) to generate an output text sequence.

The input is the numerical token sequence for the prompt sentence, and the output is a model-generated text that encodes an intent and parameter values, such as “Intent: call_taxi; Pickup_location: user_current_location; Pickup_time: now.”

### Step 9:

The server parses the model-generated output into structured data.

The server applies a deterministic parser that splits the output text around known delimiters (for example, semicolons between fields and colons between keys and values), trims whitespace, and normalizes field names.

The server validates each extracted parameter according to a schema (for example, checking that a time string matches a time pattern and that a location field is not empty) and converts values into internal data types.

The input is the model-generated output text, and the output is a structured data object, such as an intent record with fields “intent_type”, “pickup_location”, and “pickup_time.”

### Step 10:

The server determines the type of operation based on the intent.

The server reads the “intent_type” field from the structured data object and selects a corresponding processing path, such as a transportation arrangement path or a facility reservation path.

The server may also check optional flags in the intent indicating urgency or additional constraints.

The input is the structured data object with an intent field, and the output is a selected operation type and an associated internal handler reference.

### Step 11:

The server queries a database to obtain candidate contact entries.

The server constructs a database query using the intent parameters (for example, service area, facility category, requested time) and sends the query to an information storage device.

The server uses indexing structures (such as B-tree or hash indexes) to efficiently filter records matching geographic constraints, operational hours, or service categories.

The input is the intent parameters and query conditions, and the output is a set of candidate contact records, each containing at least contact information and provider attributes.

### Step 12:

The server ranks and selects an appropriate provider.

The server applies a scoring algorithm that computes a score for each candidate record based on factors such as estimated response time, historical success rate, and user preference profiles.

The server sorts the candidates by score and selects one or more top-ranked providers for the outgoing communication.

The input is the set of candidate contact records, and the output is a selected provider record that includes a destination address, such as a telephone number.

### Step 13:

The server prepares call control parameters for the communication service.

The server constructs a call request object that includes the selected provider's contact information, the caller identifier, and control parameters such as timeout values, retry limits, or routing preferences.

The server may also generate a text description of the reservation or arrangement, including the extracted parameters (for example, time and location), for use by a text-to-speech engine. The input is the selected provider record and the structured intent data, and the output is a call request object and a text message describing the requested service.

### Step 14:

The server performs text-to-speech conversion for call audio content, if needed.

The server sends the text message to a text-to-speech module that analyzes the text, converts it into phonetic and prosodic information, and synthesizes an audio waveform.

The server receives the synthesized audio file or audio stream and associates it with the call request object for playback during the call.

The input is the text message describing the booking details, and the output is an audio signal or file that can be transmitted in the voice channel.

### Step 15:

The server initiates an outgoing communication using a communication service.

The server calls a communication service API with the call request object, including destination contact information, call control parameters, and a reference to the audio content if text-to-speech is used.

The server waits for status updates (such as ringing, answered, completed) from the communication service and logs event data in an internal status tracker.

The input is the call request object and optional audio content, and the output is a communication session establishment and status reports from the communication service.

### Step 16:

The server records the result of the arrangement or reservation.

The server receives final status information from the communication service, such as whether the call was answered and whether the reservation was confirmed by an external system or operator.

The server writes a reservation record to the database, including user identifier, provider identifier, scheduled time, status code, and any confirmation code or textual note returned from the call.

The input is the call status and confirmation information, and the output is a stored reservation or arrangement record in the database.

### Step 17:

The server generates notification information for the user.

The server constructs a notification message summarizing the outcome, such as “Taxi has been arranged and will arrive in approximately 10 minutes” or “Restaurant reservation confirmed for 7:00 PM for two people.”

The server formats this message together with structured data (for example, provider name and time) into a payload suitable for push notification or a persistent connection.

The input is the reservation record stored in the database, and the output is a notification payload object.

### Step 18:

The server transmits the notification to the terminal.

The server sends the notification payload to the terminal using a push notification service or an established bidirectional communication channel.

The server may set message priority and type indicators to allow the terminal to handle the notification appropriately.

The input is the notification payload object, and the output is a network message delivered to the terminal.

### Step 19:

The terminal receives and interprets the notification.

The terminal listens for incoming messages from the server, decodes the received payload, and extracts the text message and structured details.

The terminal updates an internal list of reservations and may store the notification in local memory for future reference.

The input is the network message from the server, and the output is an internal notification object and updated local storage.

### Step 20:

The terminal presents the notification to the user.

The terminal displays the message on the display unit, showing details such as provider name, scheduled time, and current status, and may also use a local text-to-speech engine to read the message aloud.

The terminal may allow the user to acknowledge the notification, open a details screen, or perform follow-up actions such as cancellation or modification.

The input is the internal notification object, and the output is a visual and/or auditory presentation of the reservation or arrangement result to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional communication support systems that perform call screening, reservation handling, ordering, and user assistance typically treat speech recognition, rule-based intent parsing, and network control as independent components. Such systems generally rely on fixed decision trees or manually crafted rules to classify caller safety, interpret user requests, and determine network or service actions. As a result, they exhibit several technical limitations at the level of computer functionality.

First, conventional systems require separate pipelines for call risk evaluation, intent understanding, and emotion handling, which leads to duplicated parsing logic and redundant data movement between modules. This fragmentation increases processing latency, memory usage, and inter-module communication overhead inside server hardware, and makes it difficult to adapt processing logic to new patterns of fraud, new service types, or changing user behavior.

Second, known systems do not systematically utilize generative AI models through machine-readable prompt sentences as a central control primitive for server behavior. Instead, they typically apply discriminative models or static rules without dynamically generating prompts that fuse multiple data modalities (caller information, transcribed content, user intent, emotion state, network state). Consequently, the server cannot flexibly synthesize decision policies for call screening, service orchestration, or network configuration in response to complex, multi-factor contexts, and the computational path remains rigid and sub-optimal.

Third, emotion information, when used at all, is often added as an after-the-fact layer to modify output text, without being deeply integrated into the computational control loop. Emotion is not treated as structured state that directly influences how the server allocates resources, selects external services, or configures communication paths. This leads to a user interface that may seem adaptive at the surface, while the underlying computing system still performs the same fixed operations, thereby failing to improve the internal efficiency or robustness of the server.

Fourth, in optical-network environments, conventional resource control typically relies on static provisioning or low-level heuristics that are not coordinated with high-level application state. For example, changes in call volume, fraud risk patterns, or emotion-dependent service flows are not propagated back into the control of optical interfaces and bandwidth allocation. As a result, the server cannot optimize end-to-end performance or reliability across application logic and transport-layer resources.

Accordingly, there is a need for a computer-implemented system that technically improves the operation of a server by: (i) unifying call screening, user intent interpretation, emotion estimation, and network control into a single prompt-driven control architecture; (ii) using generative AI models as a programmable decision engine through dynamically generated prompt sentences derived from multi-modal analysis; and (iii) feeding back the outputs of these models directly into low-level communication and service-execution mechanisms. Such a system should reduce redundancy in parsing and decision logic, lower processing latency, and enhance the adaptability and robustness of call handling, service execution, and communication-interface control in real-time environments.

The specific processing by the specific processing unit 290 of the data processing device 12 in Application Example 2 is realized by the following means.

The present invention provides a server comprising a processor configured to receive incoming communication signals and extract source identification information, to compare the identification information with information stored in a storage device and generate risk evaluation information for communications from unknown sources, to obtain conversation or message content related to an unknown source by performing audio or character analysis and generate, based on analysis target information including a result of the obtaining, a prompt sentence for input to a generative AI model to cause the generative AI model to output an evaluation result regarding source safety, to convert audio data obtained from a user into character data by performing speech recognition, perform intent interpretation on the character data and generate, based on analysis target information including a result of the intent interpretation, a prompt sentence for input to the generative AI model to cause the generative AI model to output control information for performing arrangement processing related to a transportation means or facility use, to perform emotion estimation on audio data and/or image data obtained from the user and generate, based on an estimated emotional state, a prompt sentence for input to the generative AI model to cause the generative AI model to output control information for adjusting service content or response expression, to execute, based on evaluation results or instruction content output from the generative AI model, at least one of an audio call, message transmission, reservation request, or order request automatically through an external communication control device, and to generate and transmit, to a user terminal, response information including at least one of the evaluation result, service proposal content, emotion-adaptive message, and processing result so as to be displayed or output as audio on the user terminal. This enables the server to implement an integrated prompt-driven control loop in which multi-modal analysis results are converted into machine-readable prompt sentences, processed by the generative AI model, and fed back as executable control actions, thereby reducing redundant parsing logic, improving decision accuracy and latency in call screening and service execution, and dynamically optimizing communication and service behavior according to caller safety, user intent, user emotion, and network state.

The term “incoming communication signal” refers to a signal representing a request for communication received by the server from an external communication device or network, including at least one of a call setup signal, a data packet, or a message request.

The term “source identification information” refers to information indicating an origin of a communication, including at least one of a calling number, a network address, an account identifier, or protocol-level header information.

The term “storage device” refers to any hardware capable of storing data, including at least one of a semiconductor memory, a magnetic storage device, an optical storage device, or a non-volatile memory.

The term “risk evaluation information” refers to data indicating a degree of safety or danger associated with a communication, including at least one of a risk level, a probability value, or a classification label representing suspected fraud or solicitation.

The term “unknown source” refers to a communication origin for which the source identification information is not registered as trusted in the storage device or cannot be matched to pre-stored reference information.

The term “conversation content” refers to audio or text data representing spoken dialogue exchanged during a communication session.

The term “message content” refers to audio, text, or structured data representing a non-voice message, including at least one of a voicemail, a text message, or a signaling message body.

The term “audio analysis” refers to processing applied to audio data to extract information, including at least one of feature extraction, speech recognition, speaker identification, or noise reduction.

The term “character analysis” refers to processing applied to text data to extract information, including at least one of tokenization, syntactic analysis, semantic analysis, or entity extraction.

The term “analysis target information” refers to information that is used as input to an analysis or decision process, including at least one of extracted features, intermediate interpretation results, metadata, and context data.

The term “generative AI model” refers to a machine-implemented model configured to generate output data in response to input data, using statistical learning or neural network techniques, and capable of producing natural-language text, structured data, or control directives.

The term “prompt sentence” refers to a machine-readable text or data sequence provided as input to a generative AI model in order to specify a task, a context, or a desired format of output.

The term “evaluation result” refers to output data generated by the generative AI model or another analysis module that indicates an assessment, including at least one of a classification label, a score, a ranking, or a descriptive explanation.

The term “audio data” refers to digital data representing sound, including at least one of voice signals, environmental sounds, or combined multi-channel audio.

The term “speech recognition” refers to processing that converts audio data representing human speech into corresponding text data.

The term “character data” refers to data representing text, including at least one of encoded characters, strings, or tokens.

The term “intent interpretation” refers to processing that determines a user's purpose or requested action from text or other input data, including at least one of command extraction, slot filling, or dialogue act classification.

The term “transportation means” refers to a facility or service used for moving persons or goods, including at least one of a vehicle service, a ride service, a public transportation service, or a delivery service.

The term “facility use” refers to utilization of a physical or virtual resource, including at least one of access to a venue, use of equipment, or participation in an event.

The term “emotion estimation” refers to processing that determines an emotional state from input data, including at least one of estimating levels of anger, joy, sadness, fear, or calmness.

The term “image data” refers to digital data representing still images or video frames obtained from an imaging device.

The term “emotional state” refers to a condition of a user inferred from input data, represented by at least one of discrete labels, continuous scores, or multidimensional vectors indicating affective attributes.

The term “service content” refers to information about a function provided to a user, including at least one of recommendations, actions, notifications, or configuration changes.

The term “response expression” refers to a format or style in which information is returned to a user, including at least one of wording, tone, length, or modality of the response.

The term “external communication control device” refers to a device or software component that controls communication with an external network or endpoint, including at least one of a telephony server, a messaging gateway, or a network controller.

The term “audio call” refers to a communication session in which audio data is exchanged between endpoints over a communication network.

The term “message transmission” refers to sending of data representing text, audio, or other content from the server to an external device or service.

The term “reservation request” refers to data representing a request to allocate resources at a future time, including at least one of a booking for a service, a seat, or a time slot.

The term “order request” refers to data representing a request to purchase or obtain goods or services.

The term “user terminal” refers to an information processing device used by a user, including at least one of a mobile device, a stationary terminal, a wearable device, or a computing system with input and output interfaces.

The term “response information” refers to data generated by the server for presentation to a user, including at least one of evaluation results, instructions, confirmations, warnings, or explanations.

The term “service proposal content” refers to information describing one or more candidate services or actions recommended to a user.

The term “emotion-adaptive message” refers to response information whose content or style has been adjusted based on an estimated emotional state of a user.

The term “processing result” refers to information indicating an outcome of processing performed by the server, including at least one of success, failure, status, or result details.

The term “service providing device” refers to an external system or device that executes a service in response to control from the server, including at least one of a reservation management system, an ordering system, or a transportation dispatch system.

The term “communication control device” refers to a component that mediates exchange of data between the server and an external device or network, including at least one of a gateway, a router, a switch, or a software communication module.

The term “communication interface” refers to a hardware or software interface used for data transmission and reception, including at least one of a network port, a wireless interface, or a logical communication endpoint.

The term “optical communication device” refers to a device that transmits or receives data by using optical signals over an optical medium.

The term “optical signal” refers to a signal that conveys information by modulating light in an optical medium.

The term “electric signal” refers to a signal that conveys information by electrical characteristics within an electrical conductor or circuit.

The term “state information” refers to data representing an operational condition of a component or communication path, including at least one of load, error status, throughput, delay, or link quality.

The term “desired communication conditions” refers to target properties for communication, including at least one of required bandwidth, latency, reliability level, or priority.

The term “control policy” refers to data specifying how a system should configure or adjust its behavior, including at least one of parameter settings, rule selections, or action sequences.

The term “optical communication path” refers to a logical or physical route for optical signal transmission between endpoints.

The term “bandwidth use conditions” refers to constraints or target values that define how much communication capacity is allocated or used over a communication path.

The term “operation conditions” refers to settings that determine behavior of a device, including at least one of power level, modulation scheme, channel allocation, or connection state.

Server, terminal, and user cooperate to implement embodiments of the present invention. Server executes computer programs stored in a non-transitory storage device, terminal provides input and output interfaces, and user interacts with the system primarily through natural-language utterances and simple confirmations. Server operates as a network-connected computing apparatus including at least one central processing unit (CPU), a main memory, a storage device, a network interface controller, and, in some embodiments, an optical transceiver. Terminal operates as a general-purpose or special-purpose computing device such as a mobile device, a stationary terminal, or a wearable device equipped with a microphone, a loudspeaker, a display, a camera, and a communication interface.

Server uses a telephony software stack, such as a software-based private branch exchange, to receive incoming communication signals from fixed communication devices or networks. Server parses signaling messages (for example, session initiation signaling), extracts source identification information such as a caller identifier or network address, and stores this information in a structured table in a relational database system such as a generic relational database management system. Server also uses a network stack provided by an operating system to receive packet-based messages from terminals and external service systems.

Server implements a risk evaluation module that compares the extracted source identification information to reference entries in the database. Server maintains a table containing known safe sources, known fraudulent or suspicious sources, and associated risk scores. Server performs a lookup operation using an index on the source identification field and generates risk evaluation information indicating whether the source is “known safe,” “known suspicious,” or “unknown.” Server also computes a numeric risk score using a stored model or heuristic that takes into account factors such as call frequency, time of day, geographic origin, and historical user feedback. This pre-filtering reduces the amount of data that must be processed by later, more expensive analysis modules, thereby improving overall computational efficiency.

Server acquires conversation content or message content from communications with unknown sources. Server controls an audio capture module in the telephony software to record a segment of the caller's speech after an automated prompt. Server then submits the recorded audio segment to a speech recognition engine, such as a cloud-based or on-premise speech-to-text service, which returns character data representing the transcribed content. Server further performs character analysis using a natural-language processing library to tokenize the text, identify parts of speech, and extract semantic units such as imperative phrases (“must invest now”), time expressions, and monetary amounts.

Server constructs analysis target information as a structured data object that includes, for example, the caller identifier, risk evaluation information, a text transcript, extracted entities, and metadata such as call duration. Server uses this analysis target information to generate a prompt sentence for a generative AI model. Server formats the prompt sentence as natural-language text that defines the task, describes the input context, and constrains the output format. For example, server generates a prompt sentence such as:

“The following phone transcript may be a sales pitch or a fraud attempt. Transcript: ‘If you do not invest now, you will miss a great opportunity.’ Classify the risk as SAFE, SUSPICIOUS, or FRAUD and briefly explain the reason.”

Server sends this prompt sentence to a generative AI model, which in one embodiment is implemented as a neural network of the transformer type. Server configures the generative AI model with parameters such as the number of attention layers, the hidden dimension size, the number of attention heads, and vocabulary size. Server holds in memory a set of learned weight matrices that have been trained offline using large corpora of annotated text including legitimate and fraudulent communication transcripts. During inference, server computes attention scores for each token in the prompt sentence, multiplies the token representations by the corresponding weight matrices, and applies non-linear activation functions. This sequence of operations produces an output token sequence that encodes an evaluation result, for example the label “FRAUD” and an explanatory sentence. Server parses this output into structured fields (risk_level and reason) for downstream use.

Server improves computer technology by using the generative AI model not merely as a classifier but as a programmable decision engine driven by dynamically generated prompt sentences that fuse multi-modal data. Server avoids maintaining a large set of rigid rule trees by encoding decision policies within the generative AI model's weight matrices. This architecture reduces the size and complexity of hand-coded decision logic, decreases branching overhead in the server's control flow, and allows a single call to the generative AI model to replace multiple cascaded classifiers and rule engines. As a result, server reduces processing latency and memory footprint compared with conventional architectures that replicate parsing and decision logic in separate modules.

Server interprets user requests received from terminal in a similar manner. Terminal captures audio from user using an operating system audio capture interface, digitizes the signal into linear pulse-code modulation format, and transmits audio data to server over a secure network connection. Server performs speech recognition to convert the audio data into character data and stores the resulting text in a database. Server executes an intent interpretation module that uses both rule-based parsing and statistical models to identify the action requested by user, such as “order,” “reserve,” “cancel,” or “inquire.” Server also extracts parameters such as item type, quantity, date and time, and location.

Server then generates a prompt sentence for the generative AI model that encodes the interpreted intent and extracted parameters. For example, server generates a prompt sentence such as:

“User request: ‘Order a large margherita pizza to my home.’ Extract a structured order including size, type, quantity, and address, and generate a concise confirmation message for the user.”

Server supplies this prompt sentence to the generative AI model. The model processes the sequence as input tokens, uses self-attention mechanisms to learn dependencies between tokens such as “large,” “pizza,” and “home,” and outputs a structured description in text form indicating a complete order. Server parses the generated text to identify key-value pairs and confirmation messages. Server thereby obtains both machine-readable control parameters for external service systems and human-readable messages for user. This joint generation reduces the number of separate text processing stages and avoids redundant template construction that would otherwise be performed by custom code.

Server uses the generative AI model in conjunction with an emotion estimation module. Terminal captures additional data from user, such as facial images or video frames, and sends this data to server. Server extracts features such as facial landmarks, eye openness, and mouth curvature using an image processing library. Server also measures audio features including pitch, energy, and speech rate using digital signal processing routines. Server feeds these features into a trained emotion classifier, such as a feedforward or recurrent neural network, that outputs an estimated emotional state, expressed as scores for categories such as anger, joy, fear, or calmness.

Server then generates a prompt sentence that includes both the user request and the estimated emotional state. For example, server generates a prompt sentence such as:

“User request: ‘I am tired and anxious; please arrange something relaxing for dinner.’ Detected emotion: tired and slightly anxious. Suggest two or three food and drink options that help people relax, and generate a short, empathetic explanation in a friendly tone.”

Server sends this prompt sentence to the generative AI model, which generates recommendations and emotion-sensitive text. Server uses this output to determine specific actions, such as ordering certain products or adjusting the style of messages returned to user. Server thereby creates a control loop where emotion is not merely an output decoration but an input variable that directly influences decision-making and resource allocation.

Server improves the functioning of the computer system by integrating emotion state into the control path rather than treating it as a post-processing effect. Server adjusts its internal thresholds for risk evaluation, its choice of external service providers, and its strategy for network resource allocation based on predicted user emotion. For example, server may lower latency thresholds and prioritize more robust communication paths when user is classified as anxious, thereby reducing the probability of noticeable delay or connection failure. This cross-layer optimization between application state and communication resources provides a technical effect beyond simple user interface personalization.

Server interacts with external communication control devices to carry out actions in the real world. Server uses a telephony gateway or messaging gateway to establish audio calls and send messages to external service systems such as reservation management servers or ordering servers. Server constructs control messages that include parameters derived from the generative AI model output. Server sends these control messages using application programming interfaces such as web-based APIs, which trigger actual reservations, product orders, or vehicle dispatches in external systems. Server also receives status updates and completion confirmations from external systems and forwards them to terminal for presentation to user.

Server controls a communication interface connected to an optical communication device to achieve high-speed and reliable data transmission. Server manages an optical transceiver to convert electric signals into optical signals and vice versa. Server collects state information such as link utilization, error rates, and latency from the optical communication device using low-level monitoring interfaces. Server combines this state information with application-level metrics such as current call volume and emotion-dependent service flows to construct analysis target information for network control.

Server generates a prompt sentence for the generative AI model that describes the observed state and desired communication conditions. For example, server generates a prompt sentence such as:

“Current optical link utilization is 80 percent with increasing call volume and high priority traffic from anxious users. Propose a control policy to adjust bandwidth allocation and prioritize low-latency paths for critical traffic.”

Server sends this prompt sentence to the generative AI model, which outputs a control policy in text form. Server parses the policy into specific configuration parameters such as revised quality-of-service classes or bandwidth reservations and applies these parameters through management protocols of the optical communication device. Server thereby uses the generative AI model to synthesize non-obvious control strategies that adapt dynamically to complex, multi-factor network conditions, improving throughput and reliability beyond static or heuristic approaches.

Server executes these operations using a modular software architecture. Server divides functionality into modules such as a call intake module, a text processing module, an emotion module, a prompt generation module, a generative AI interface module, a decision engine, a network control module, and an external service integration module. Each module exposes defined interfaces, and data flows between modules in structured records that contain identifiers, transcripts, features, risk scores, emotions, and model outputs. Server processes each record through a pipeline that may branch and merge based on intermediate results. This architecture reduces inter-module coupling, simplifies debugging, and allows incremental deployment of improved models and algorithms without redesigning the entire system.

Server trains the generative AI model and emotion classifier offline using stored datasets. Server uses a supervised learning method for the emotion classifier, minimizing a cross-entropy loss function between predicted emotion labels and ground-truth labels. Server updates model weights using gradient-based optimization such as stochastic gradient descent with adaptive learning rate. Server deploys the trained weight values to the runtime environment and may periodically retrain or fine-tune models using newly collected data and user feedback. For the generative AI model, server uses a language modeling objective to learn token probabilities from large corpora and may further fine-tune the model on domain-specific prompts and responses. Server manages training data and model versions with metadata stored in the database so that each inference call can be associated with a particular model revision and training dataset.

Server improves computer technology relative to conventional rule-based systems by combining multiple functions into a unified prompt-driven control framework. In conventional systems, separate modules for fraud classification, intent detection, and network control each maintain independent rule sets and data representations, causing duplication and inconsistency. In contrast, server of the present invention encodes high-level decision logic in prompt sentences and uses the generative AI model as a shared reasoning component. This reduces the volume of hand-maintained rules, simplifies software updates, and allows consistent handling of new patterns across different functions. Furthermore, server's use of shared analysis target information reduces redundant parsing and feature extraction, leading to lower CPU utilization and faster response times.

Terminal operates as the user-facing endpoint of the system. Terminal provides user with audio and visual output based on response information received from server. Terminal displays risk warnings about incoming calls, confirmation messages for reservations and orders, and explanation of network state or quality of service if desired. Terminal also plays emotion-adaptive messages using a built-in or external audio device. Terminal optionally provides user with controls for overriding automated decisions, giving feedback about correctness of fraud classification or quality of recommendations. Terminal sends this feedback to server, which records it for future model fine-tuning and prompt optimization. User interacts with terminal predominantly through speech, but user may also interact through touch, gestures, or text input. User does not need to understand the internal operation of the system; user simply issues natural-language requests and receives corresponding responses or actions. The technical advantages of the invention are realized in the improved performance, robustness, and flexibility of the server's internal processing, not merely in the user experience.

Alternative embodiments of the invention are possible. Server may implement different types of generative AI models, such as encoder-decoder architectures or recurrent neural networks, instead of transformer-only architectures. Server may also employ on-device models in terminal for preliminary emotion estimation or speech recognition, with server performing higher-order reasoning and network control using aggregated results. Server may use different optimization algorithms, feature sets, or network protocols while maintaining the core concept of generating prompt sentences from multi-modal analysis target information and using the resulting generative AI outputs to control communications, services, and network resources.

Server and terminal together thus provide a concrete technical implementation that ties advanced AI processing to real-world device control and communication management. Server executes specific data transformations and control actions that improve processing speed, decision accuracy, and resource utilization, and that reduce communication load by avoiding unnecessary external calls and by dynamically shaping network traffic. These improvements arise from the particular combination of multi-modal analysis, structured analysis target information, prompt sentence generation, and use of a generative AI model as an integrated decision engine, rather than from mere automation of human decision-making processes.

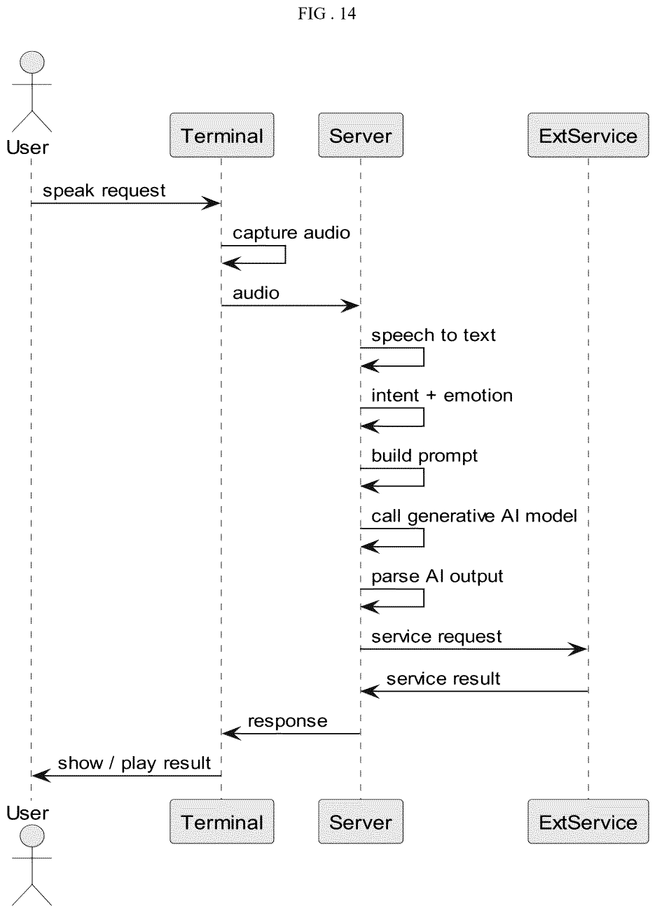

The following describes the processing flow using FIG. 14.

### Step 1:

User issues a request.

User speaks a natural-language utterance such as “Order a large margherita pizza to my home,” “Book a taxi to the airport at 8 p.m.,” or “I am tired and anxious; please arrange something relaxing for dinner.”

Input: spoken voice signal from user.

Output: analog audio captured by the microphone of terminal.

### Step 2:

Terminal captures and digitizes audio.

Terminal activates its microphone interface, samples the analog audio at a defined sampling rate (for example, 16 kHz), quantizes it using a pulse-code modulation scheme, and buffers the resulting audio samples in memory. Terminal optionally encodes the audio using a compression codec such as a wideband audio codec to reduce bandwidth. Terminal attaches metadata including user identifier, language setting, and timestamp.

Input: analog audio signal from user.

Output: digital audio buffer (for example, PCM or compressed frames) with associated metadata.

### Step 3:

Terminal transmits audio to server.

Terminal establishes a secure connection (for example, HTTPS or a secure WebSocket) to server and sends a request message that contains the digital audio buffer and metadata. Terminal performs packetization and segmentation when necessary so that the audio stream fits within network packet size constraints.

Input: digital audio buffer and metadata stored on terminal.

Output: network packets carrying the audio data and metadata delivered to server.

### Step 4:

Server receives and stores audio data.

Server accepts the incoming network connection, reconstructs the digital audio buffer from received packets, and verifies integrity using checksums or sequence numbers. Server writes the raw audio buffer and associated metadata into a storage component, such as a database record or file storage, and assigns a unique request identifier.

Input: network packets carrying audio data and metadata.

Output: stored audio data object identified by a request ID and linked metadata.

### Step 5:

Server performs speech recognition to obtain text.

Server sends the stored audio buffer to a speech recognition engine via an application programming interface, specifying language and audio encoding parameters. Server waits for the speech recognition engine to process the audio and return a text transcript. Server receives the transcript string and a confidence score, then stores these in a text field associated with the request ID.

Input: digital audio buffer and language parameters.

Output: text transcript of the user utterance and recognition confidence value.

### Step 6:

Server performs intent interpretation and entity extraction.

Server applies a natural-language processing module to the text transcript to identify the type of request (for example, order, reservation, inquiry) and to extract parameters such as item name, size, quantity, date, time, and location. Server tokenizes the text, assigns part-of-speech tags, and uses pattern rules or a trained model to map phrases to semantic slots. Server writes the recognized intent and extracted slot values into structured fields in the database.

Input: text transcript of the user utterance.

Output: interpreted intent label (for example, ORDER_FOOD, RESERVE_TRANSPORT) and structured parameters (for example, {item: pizza, size: large, address: home}).

### Step 7:

Server estimates user emotion from audio and/or image data.

Server optionally retrieves the original audio buffer and, if available, image frames captured by terminal. Server computes acoustic features such as pitch contour, energy, and speech rate from the audio samples using digital signal processing routines. Server also computes visual features such as facial landmarks and expression scores from image data using an image processing library. Server inputs these feature vectors into an emotion classifier model that outputs an estimated emotional state and associated confidence values.

Input: audio features and, optionally, image features derived from the original user data.

Output: estimated emotion label (for example, “tired and slightly anxious”) and numeric scores per emotion category.

### Step 8:

Server constructs analysis target information.

Server aggregates the interpreted intent, extracted parameters, emotion label, metadata (user ID, time, device type), and, when relevant, previous interaction context into a single structured record. Server also retrieves application-specific knowledge such as the user's profile address or past preferences from the database and adds this information to the record.

Input: intent label, structured parameters, emotion estimates, metadata, and user profile data.

Output: analysis target information object combining all relevant fields for this request.

### Step 9:

Server generates a prompt sentence for the generative AI model.

Server formats the analysis target information into a natural-language instruction that describes the task, context, and desired output structure. For example, when user requests a pizza order, server generates a prompt sentence such as:

“User request: ‘Order a large margherita pizza to my home.’ Extract a structured order including size, type, quantity, and address, and generate a concise confirmation message for the user.”

When user expresses anxiety and asks for a relaxing dinner, server generates a prompt sentence such as:

“User request: ‘I am tired and anxious; please arrange something relaxing for dinner.’ Detected emotion: tired and slightly anxious. Suggest two or three food and drink options that help people relax, and generate a short, empathetic explanation in a friendly tone.”

Input: analysis target information object for the current request.

Output: prompt sentence text suitable for input to the generative AI model.

### Step 10:

Server invokes the generative AI model with the prompt sentence.

Server sends the prompt sentence to the generative AI model through an inference interface, specifying model parameters such as maximum output length and temperature. Server encodes the prompt sentence as a sequence of tokens, forwards the token sequence to the model, and triggers computation across the model's neural network layers. Server receives the model's output tokens, decodes them into a text response, and stores this response along with the request ID.

Input: prompt sentence text and model configuration parameters.

Output: generated text output containing structured information and user-oriented explanation.

### Step 11:

Server parses and structures the generative AI output.

Server analyzes the generated text to extract structured fields that represent concrete actions or data, such as an order specification or a risk classification. Server applies pattern matching, delimiter recognition, or lightweight natural-language parsing to divide the output into a machine-readable part (for example, “order one large margherita pizza to address X”) and a human-readable message (“I will order one large margherita pizza to your home address”). Server writes the machine-readable portion into control parameters and stores the human-readable part as a confirmation message.

Input: generated text output from the generative AI model.

Output: control parameters for external systems and a confirmation message for user.

### Step 12:

Server decides and executes external service actions.

Server uses the control parameters to determine which external service systems, such as reservation servers or ordering servers, must be contacted. Server constructs API requests or call scripts that contain destination identifiers (for example, phone numbers or URLs) and relevant parameters like items, times, and addresses. Server sends these requests through a communication control device; for example, server may initiate a voice call via a telephony gateway or send a structured message via a web-based API endpoint. Server monitors the response or call status returned by the external system and updates the internal record with success, failure, or pending status.

Input: control parameters derived from the generative AI output.

Output: external service invocations and resulting status information stored in the server database.

### Step 13:

Server prepares response information for terminal.

Server composes response information that includes at least the human-readable confirmation message, the status of any external actions, and, if relevant, emotion-sensitive wording reflecting the estimated emotional state. Server may also include risk warnings, suggestions, or explanations generated by the generative AI model. Server optionally converts the confirmation text into audio using a text-to-speech engine.

Input: confirmation message, action status data, and emotion estimates.

Output: response payload containing text, optional audio, and metadata ready to be sent to terminal.

### Step 14:

Server sends response information to terminal.

Server transmits the response payload to terminal over the established secure connection. Server ensures that large audio files or additional data are segmented and transmitted in a way compatible with terminal's capabilities. Server records transmission completion or errors for diagnostic purposes.

Input: response payload constructed by server.

Output: network packets carrying the response information to terminal.

### Step 15:

Terminal presents response to user.

Terminal receives the response payload, reconstructs any audio or text data, and presents the information to user. Terminal displays the confirmation message and related details on the screen and, if audio is provided, plays back the audio through the speaker. Terminal may also highlight warnings or recommendations using visual indicators.

Input: response payload received from server.

Output: visual and/or audio output observable by user.

### Step 16:

User optionally provides feedback or additional instructions.

User reviews the confirmation message and the results of the external actions. User may approve the action, reject it, request modifications, or provide feedback on accuracy or helpfulness by speaking or selecting interface elements on terminal.

Input: displayed or spoken response provided by terminal.

Output: user's additional spoken or manual input to terminal.

### Step 17:

Terminal and server process feedback and refine future behavior.

Terminal captures the feedback input in the same manner as the original request and forwards it to server. Server records the feedback in association with the corresponding request and generative AI output. Server uses this stored feedback in offline training or fine-tuning processes to adjust model parameters or to modify future prompt sentence templates, thereby improving decision accuracy and response quality in subsequent operations.

Input: feedback data from user transmitted via terminal.

Output: updated training or configuration data stored by server for future processing.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

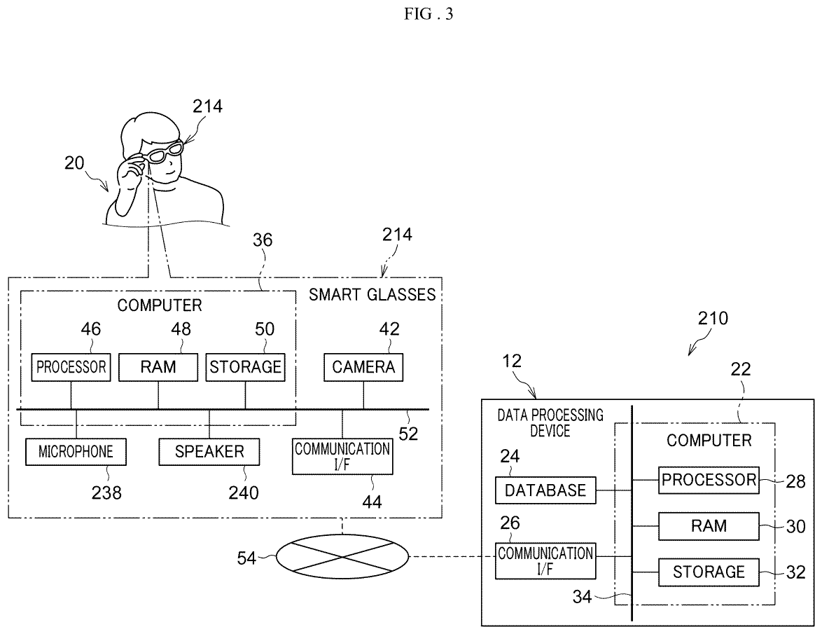

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

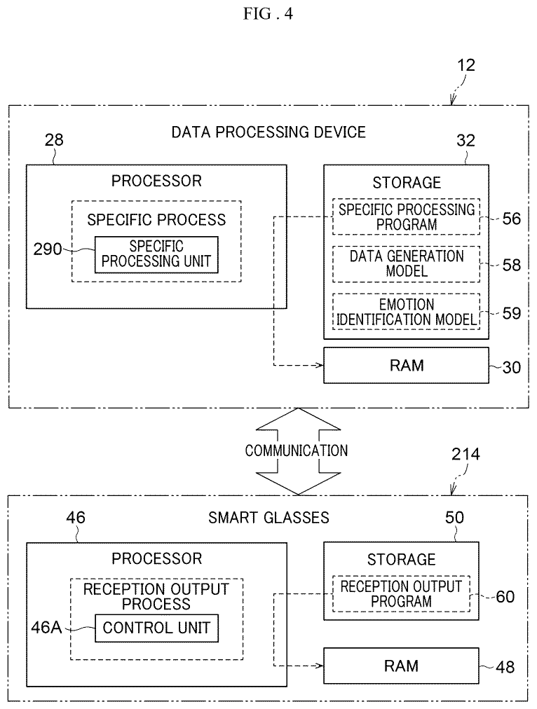

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

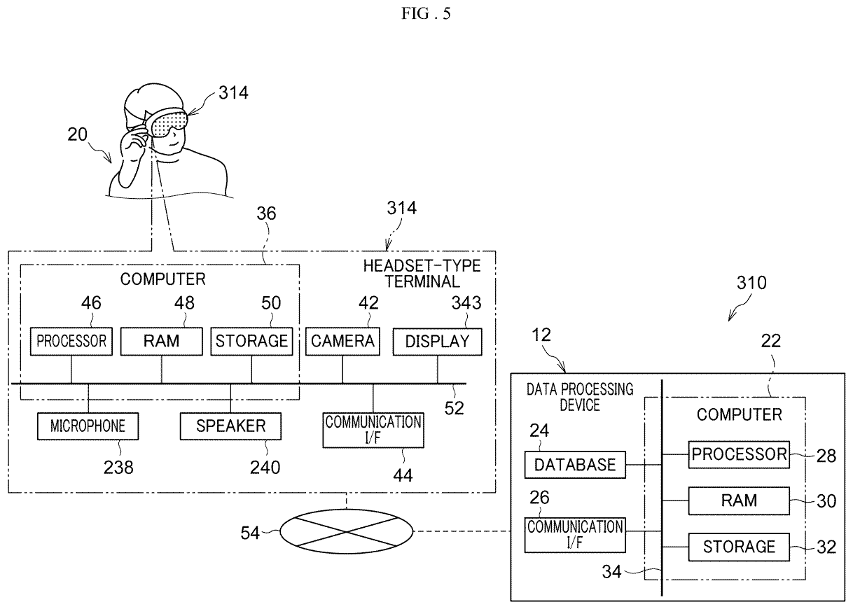

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

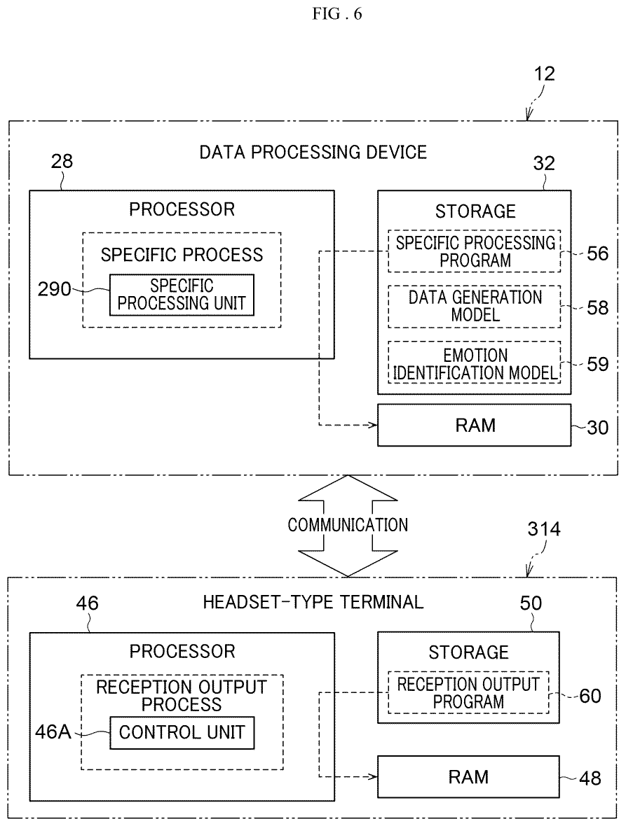

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

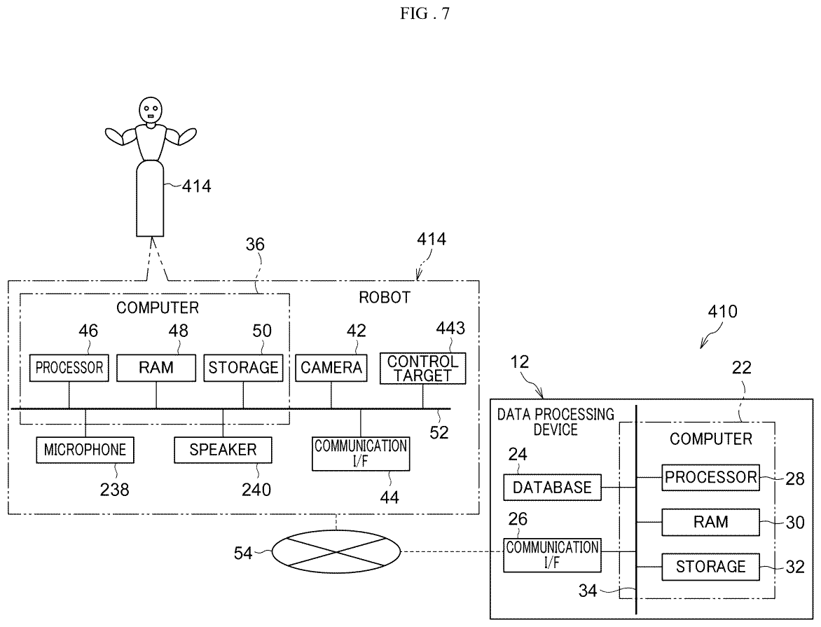

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

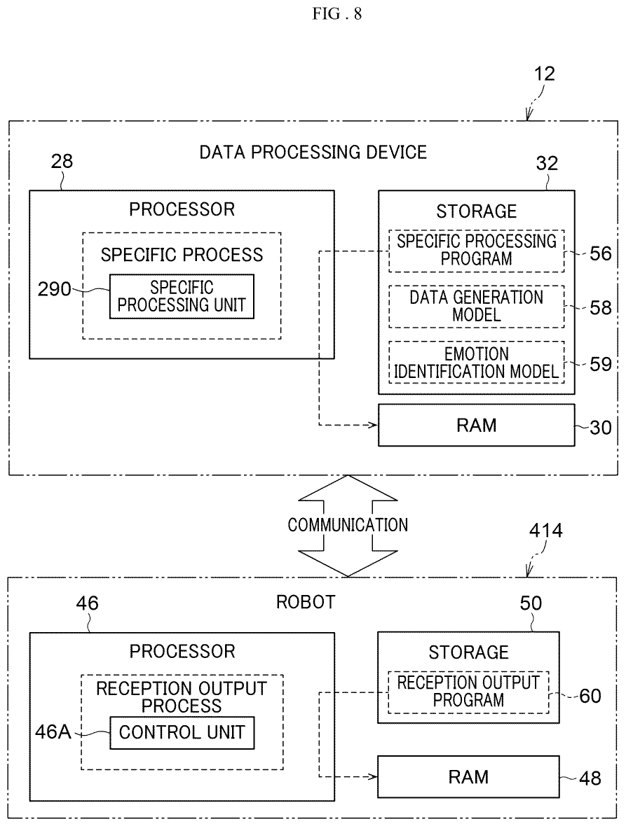

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

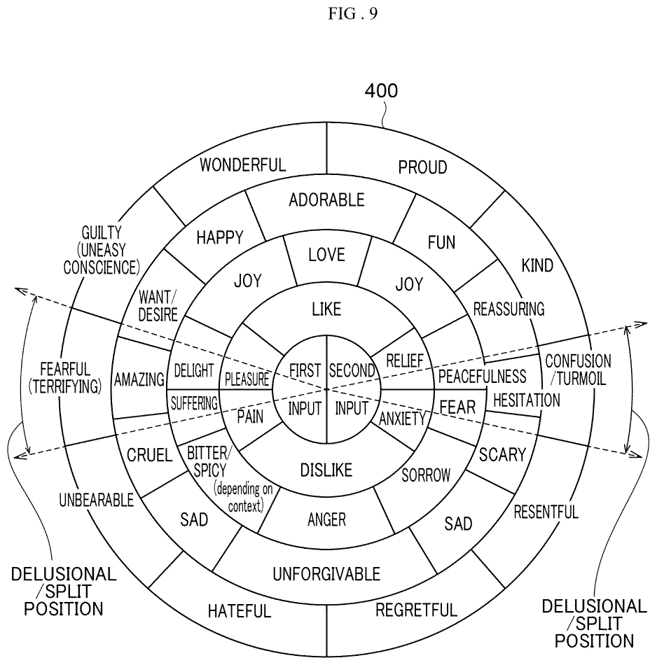

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

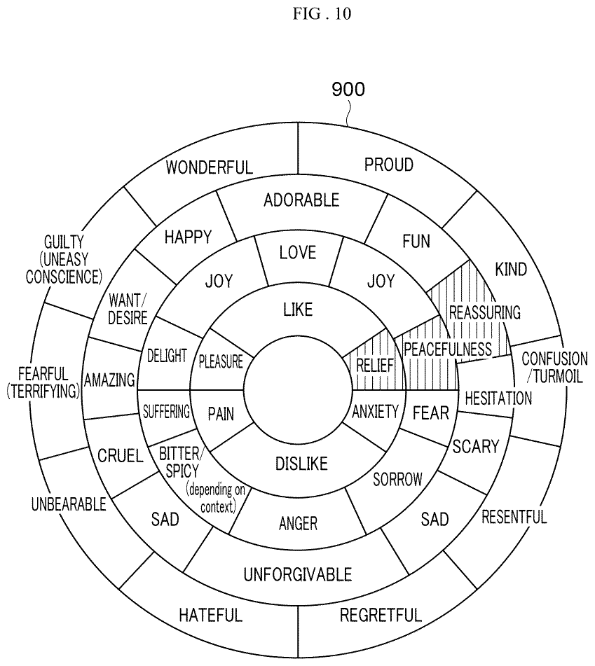

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
receive an input signal from a communication apparatus, extract incoming information including identification information from the input signal, and perform initial processing of the incoming information,
compare the identification information with information stored in the storage device,
determine whether the identification information corresponds to known information or unknown information, and perform risk evaluation on the identification information determined to be unknown,
generate a prompt sentence requesting an evaluation of safety with respect to the identification information determined to be unknown, and transmit the prompt sentence and the identification information to an external generative AI model to obtain a safety evaluation result,
analyze the safety evaluation result received from the generative AI model, generate a determination result indicating whether a communication corresponding to the identification information is to be permitted or rejected, and record the determination result and the safety evaluation result in the storage device,
generate a connection control signal for the communication apparatus based on the determination result, and transmit the connection control signal to the communication apparatus to control a connection state of the communication apparatus,
when the determination result indicates permission, transmit notification information including the identification information, the safety evaluation result, and response options for the communication to a terminal device, receive a user response operation from the terminal device, and control establishment or termination of the communication based on the user response operation, and
update at least one of content of the prompt sentence and a threshold used for the determination result based on the safety evaluation result, the determination result, and the user response operation, and dynamically adjust subsequent safety evaluation processing.

### (Supplementary 2)

The system according to supplementary 1,
wherein the processor is configured to
acquire user voice input from the terminal device, interpret the user voice input as a reservation request or an order request by performing voice recognition processing, generate a prompt sentence to be transmitted to the external generative AI model based on an interpretation result, and automatically execute an outgoing process for reservation or ordering via the communication apparatus based on a response result obtained from the generative AI model.

### (Supplementary 3)

The system according to supplementary 1,
wherein the processor is configured to
control an optical communication element that receives an optical signal, generate connection control information for converting the optical signal into an electrical signal and connecting the electrical signal to a communication network, create a prompt sentence for generating the connection control information, and control the optical communication element and the communication apparatus based on the connection control information.

### Application Example 1

### (Supplementary 1)

A system comprising a processor, a storage device, a communication interface, and a user terminal,
wherein the processor is configured to
perform initial processing of an incoming communication signal in an information processing apparatus, receive the incoming communication signal via the communication interface, and
extract caller identification information from signaling data,
compare the extracted caller identification information with contact information and user preference information stored in the storage device, identify an unknown caller when no corresponding record is found, and perform risk evaluation for the unknown caller based on history information and external evaluation information associated with the caller identification information,
generate a prompt sentence by embedding structured data including the caller identification information, the history information, the user preference information, and a result of the risk evaluation into a natural language expression, and transmit the prompt sentence to a generative artificial intelligence model via the communication interface to obtain, from the generative artificial intelligence model, a numerical score and a classification label indicating safety of a caller,
compare the numerical score and the classification label with predetermined threshold information and the user preference information, determine a communication control policy according to a safety level, block a communication when a risk level is high, and hold a caller in a standby state when the risk level is low,
generate notification information including the caller identification information, the numerical score, the classification label, and explanatory information according to the communication control policy, and transmit the notification information to the user terminal via the communication interface so that a display device of the user terminal displays warning information or safety information,
receive, from the user terminal, selection information indicating at least one of permission of the incoming communication, rejection of the incoming communication, permanent rejection of future communications from the caller, and permanent permission of future communications from the caller, control a communication path to connect or disconnect according to the selection information, and register the caller identification information in at least one of an allow list and a deny list in the storage device,
record, in the storage device, the caller identification information, the result of the risk evaluation, an output result of the generative artificial intelligence model, and the selection information from a user as log information, and provide the log information as learning data for retraining or updating the generative artificial intelligence model,
acquire voice data of the user from a voice input device, perform voice recognition processing on the voice data to analyze the voice data, extract a request content including at least one of a reservation request and an order request, generate a prompt sentence for automatically initiating an external communication to perform the reservation or the order based on the request content, and transmit the prompt sentence to the generative artificial intelligence model,
and analyze at least one of the voice data of the user, an operation history of the user, and the output result of the generative artificial intelligence model to estimate an emotional state of the user, generate a prompt sentence for generating response content or service content corresponding to the emotional state, and transmit the prompt sentence to the generative artificial intelligence model.

### (Supplementary 2)

The system according to supplementary 1,
wherein the processor is configured to
interpret various reservation requests and order requests by the voice recognition processing, generate a prompt sentence including the reservation requests or the order requests for the generative artificial intelligence model, and, by transmitting the prompt sentence to the generative artificial intelligence model and controlling the communication interface, automatically initiate external communications to execute the reservations or the orders.

### (Supplementary 3)

The system according to supplementary 1,
wherein the processor is configured to
control a communication conversion apparatus that performs conversion between an optical signal and an electrical signal, generate, for the generative artificial intelligence model, a prompt sentence including control information for connecting the communication conversion apparatus to a communication network, obtain, from the generative artificial intelligence model, control guidance based on the prompt sentence, and control the communication conversion apparatus according to the control guidance.

### Example 2

### (Supplementary 1)

A system comprising a processor,
wherein the processor is configured to
receive a communication signal, extract source information from the communication signal, and perform risk evaluation for a source of the communication signal by collating the source information with stored information,
convert a voice signal acquired from a voice input device into character information by performing speech recognition processing, and analyze a request content of a user from the character information,
generate a prompt sentence including the request content of the user, input the prompt sentence to a generative information processing model, and acquire structured information including an intention and parameters corresponding to the request content from the generative information processing model,
search an information storage device based on the structured information and acquire contact information of a transportation means or a facility,
control an outgoing process by using a communication service having a communication function so as to automatically establish a communication connection to the acquired contact information and perform arrangement of the transportation means or reservation of the facility,
estimate an emotional state of the user based on at least one of an output of the generative information processing model and the voice signal, and select response content or service content to be provided according to the emotional state, and
generate notification information indicating a result of the arrangement of the transportation means or the reservation of the facility and cause a terminal device to present the notification information to the user.

### (Supplementary 2)

The system according to supplementary 1,
wherein the processor is configured to
analyze a request relating to a reservation or an order by using the character information obtained by the speech recognition processing, generate input information for the generative information processing model, the input information including a prompt sentence representing the request, item information required for the request, and condition information specifying an output format, acquire structured information relating to the reservation or the order from the generative information processing model, and execute the reservation or the order by an automatic outgoing process using the communication function.

### (Supplementary 3)

The system according to supplementary 1,
wherein the processor is configured to
control a communication device capable of transmitting and receiving an optical signal, convert the optical signal received by the communication device into an electric signal to connect to a communication network, and include condition information relating to a communication path via the optical signal in the prompt sentence to be input to the generative information processing model so as to execute the automatic outgoing process using the communication path.

### Application Example 2

### (Supplementary 1)

A system comprising a processor,
wherein the processor is configured to
receive an incoming communication signal and extract identification information related to a source of the incoming communication,
compare the extracted identification information with information stored in a storage device and generate risk evaluation information regarding safety of a communication from an unknown source,
obtain conversation content or message content related to the communication from the unknown source by performing audio analysis or character analysis, and, based on analysis target information including a result of the obtaining, generate a prompt sentence to be input to a generative AI model so as to cause the generative AI model to output an evaluation result regarding safety of the source,
convert audio data obtained from a user into character data by performing speech recognition processing, perform intent interpretation processing on the converted character data, and, based on analysis target information including a result of the intent interpretation processing,
generate a prompt sentence to be input to the generative AI model so as to perform arrangement processing related to a transportation means or use of a facility, perform emotion estimation processing on audio data and/or image data obtained from the user and, based on an estimated emotional state, generate a prompt sentence to be input to the generative AI model so as to adjust content of a service or an expression format of a response,
execute, based on an evaluation result or instruction content output from the generative AI model, at least one of an audio call, message transmission, reservation request, or order request automatically through an external communication control device, and
generate and transmit, to a user terminal, response information including at least one of the evaluation result output from the generative AI model, service proposal content, an emotion-adaptive message, and a processing result so as to be displayed or output as audio on the user terminal.

### (Supplementary 2)

The system according to supplementary 1,
wherein the processor is configured to
convert audio data obtained from a user into character data by performing speech recognition processing, extract information related to at least one of an item, quantity, date and time, location, and contact information for a reservation or an order from the character data,
generate, based on analysis target information including a result of the extraction, a prompt sentence to be input to the generative AI model so as to execute the reservation or the order, and, based on an output result obtained from the generative AI model, cause an external service providing device to automatically execute processing of the reservation or the order through a communication control device.

### (Supplementary 3)

The system according to supplementary 1,
wherein the processor is configured to
control a communication interface connected to a network through an optical communication device, perform mutual conversion between an optical signal and an electric signal, obtain state information regarding data transmission and reception through the communication interface, generate, based on the state information and desired communication conditions, a prompt sentence to be input to the generative AI model so as to cause the generative AI model to output a control policy related to setting of an optical communication path or adjustment of bandwidth use conditions, and control operation conditions of the optical communication device based on an output result obtained from the generative AI model.

What is claimed is:

1. A system comprising:
circuitry configured to:
receive, via a communication interface coupled to a packet-switched network, an incoming communication signal from a communication apparatus and extract identification information from signaling data of the incoming communication signal;
perform a lookup of the identification information in a caller profile table stored in a storage device to determine whether the identification information is classified as known or unknown, and perform risk evaluation on identification information determined to be unknown;
generate a prompt sentence incorporating the identification information and input the prompt sentence to a generative neural network model via the communication interface to obtain a safety evaluation result comprising a safety label and an explanation;
analyze the safety evaluation result to generate a determination indicating whether the incoming communication is to be permitted or rejected, record the determination and the safety evaluation result in the storage device, and generate a connection control signal and transmit the connection control signal to the communication apparatus to control a connection state;
transmit notification information comprising the identification information, the safety evaluation result, and response options to a terminal device via the communication interface and control establishment or termination of the incoming communication based on a user response operation received from the terminal device; and
update at least one of a prompt template stored in the storage device and a threshold parameter used in the determination based on the safety evaluation result, the determination, and the user response operation.

2. The system of claim 1, wherein the circuitry is configured to store the prompt template as a text pattern in the storage device comprising fixed text segments and a placeholder for identification information, and to generate the prompt sentence by replacing the placeholder with the extracted identification information.

3. The system of claim 2, wherein the circuitry is configured to maintain a plurality of prompt templates in the storage device associated with different risk context categories, and to select among the plurality of templates based on signaling metadata associated with the incoming communication signal.

4. The system of claim 3, wherein the circuitry is configured to record each generated prompt sentence in a prompt-log table linked to a call-session record identified by a call identifier, and to store associated AI evaluation identifiers for subsequent threshold update operations.

5. The system of claim 4, wherein the circuitry is configured to update the threshold parameter by computing a running accuracy metric from accumulated determination results and user response operations and adjusting the threshold parameter when the running accuracy metric falls below a target accuracy level.

6. The system of claim 1, wherein the generative neural network model is a transformer-based model comprising an embedding layer, multi-head self-attention layers, and feed-forward layers, and the safety evaluation result comprises a safety classification token and a sequence of explanation tokens decoded by the circuitry using beam search.

7. The system of claim 6, wherein the circuitry is configured to parse the safety classification token from the safety evaluation result and compare a confidence score associated with the safety classification token to the threshold parameter to generate the determination.

8. The system of claim 1, wherein the circuitry is configured to maintain a caller profile table wherein each record comprises a caller identifier, a classification flag, a safety label, a risk score, one or more timestamps, and a reference to a stored safety evaluation result, and to update the classification flag and the risk score upon receipt of each new safety evaluation result.

9. The system of claim 8, wherein the circuitry is configured to promote an unknown identification information record to a known classification upon receipt of a confirmed safe user response operation and to assign an updated safety label to the record in the caller profile table.

10. The system of claim 1, wherein the connection control signal is a signaling protocol message that instructs the communication apparatus to maintain a ringing state pending the user response operation, and the circuitry is configured to generate a termination control signal instructing the communication apparatus to end the incoming communication upon receipt of a rejection response operation from the terminal device.

11. The system of claim 10, wherein the circuitry is configured to receive an optical communication signal at the communication interface via an optical communication element that converts incoming optical signals into electrical signals and to output electrical signals converted by the optical communication element into optical signals for transmission to the communication apparatus.

12. The system of claim 1, wherein the circuitry is configured to receive user voice input from the terminal device, apply voice recognition processing to convert the user voice input into text, and use the resulting text to construct an outgoing process request prompt sentence for input to the generative neural network model.

13. The system of claim 12, wherein the outgoing process request prompt sentence encodes a reservation request or an order request extracted from the user voice input, and the circuitry is configured to transmit a resulting outgoing communication signal to a destination communication apparatus based on a response result obtained from the generative neural network model.

14. The system of claim 1, wherein the notification information is transmitted to the terminal device as a push notification comprising a visual summary of the safety evaluation result and interactive response option controls rendered on the terminal device.

15. The system of claim 14, wherein the circuitry is configured to enforce a response timeout interval and, upon expiration of the interval without a user response operation, apply a default determination stored in the storage device for the safety label associated with the incoming communication.

16. The system of claim 1, wherein the circuitry is configured to aggregate safety evaluation results and user response operations over a sliding time window and compute a periodic model performance metric, and to trigger an update of the prompt template content when the model performance metric decreases below a minimum performance threshold.

17. The system of claim 1, wherein the circuitry is configured to perform a batch lookup of a plurality of identification information items against the caller profile table during off-peak processing intervals and to pre-populate risk scores for identified unknown callers in the storage device prior to receipt of corresponding incoming communication signals.

18. A system comprising:
circuitry configured to:
receive an incoming communication signal via a communication interface coupled to a packet-switched network, extract identification information from signaling data, and perform a lookup against a caller profile table stored in a storage device to determine whether the identification information is known or unknown;
select a prompt template from a plurality of prompt templates stored in the storage device based on signaling metadata, generate a prompt sentence by substituting the identification information into a placeholder of the selected prompt template, and input the prompt sentence to a transformer-based generative neural network model to obtain a safety evaluation result comprising a safety classification token and explanation tokens;
parse the safety classification token and compare a confidence score to a threshold parameter to generate a determination, record the determination in the storage device, and generate a connection control signal transmitted to the communication apparatus to control a connection state;
transmit notification information comprising the identification information, the safety evaluation result, and response options to a terminal device via the communication interface, receive a user response operation, and control establishment or termination of the incoming communication based on the user response operation; and
update the threshold parameter and the selected prompt template based on a running accuracy metric computed from accumulated determination results and user response operations.

19. The system of claim 18, wherein the circuitry is configured to receive user voice input from the terminal device, apply voice recognition processing to convert the user voice input into text, construct an outgoing process request prompt sentence encoding a reservation request or order request, input the outgoing process request prompt sentence to the transformer-based generative neural network model, and transmit a resulting outgoing communication signal to a destination communication apparatus.

20. A method comprising:
receiving, via a communication interface coupled to a packet-switched network, an incoming communication signal from a communication apparatus and extracting identification information from signaling data of the incoming communication signal;
performing a lookup of the identification information in a caller profile table stored in a storage device, and generating a prompt sentence incorporating the identification information and inputting the prompt sentence to a generative neural network model to obtain a safety evaluation result;
analyzing the safety evaluation result to generate a determination,
generating a connection control signal, and transmitting the connection control signal to the communication apparatus to control a connection state;
transmitting notification information comprising the identification information, the safety evaluation result, and response options to a terminal device and controlling establishment or termination of the incoming communication based on a user response operation; and
updating at least one of a prompt template and a threshold parameter based on the safety evaluation result, the determination, and the user response operation.
